(19) United States
(12) Patent Application Publication
(10) Pub. No.: US 2026/0118136 A1
(43) Pub. Date: Apr. 30, 2026

(54) METHOD FOR GENERATING A CENTER LINE AND APPARATUS, ELECTRONIC DEVICE, AND STORAGE MEDIUM

(71) Applicant: TENCENT TECHNOLOGY (SHENZHEN) COMPANY LIMITED, Shenzhen (CN)

(72) Inventor: Yongqing JIN, Shenzhen (CN)

(21) Appl. No.: 19/373,049

(22) Filed: Oct. 29, 2025

Related U.S. Application Data
(63) Continuation of application No. PCT/CN2024/103043, filed on Jul. 2, 2024.

(30) Foreign Application Priority Data
Sep. 18, 2023 (CN) 202311200592.7

(51) Int. Cl. G01C 21/00; G06T 11/23; G06T 11/65

(52) U.S. Cl. CPC G01C 21/3822; G06T 11/23; G06T 11/65

(57) ABSTRACT

Embodiments of this application disclose a method for generating a center line, including determining, corresponding to first sampling points on a first lane line of a target lane, projection points of the first sampling point on a second lane line of the target lane as first projection points respectively corresponding to the first sampling points; dividing the second lane line into a plurality of first segment lines according to the first projection points, and dividing the first lane line into a plurality of second segment lines according to the first sampling points; selecting first reference points on the first segment lines and second reference points on the second segment lines according to a same distance proportion; and generating a lane center line of the target lane according to the first reference points and the corresponding second reference points.

### RELATED APPLICATIONS

This application claims priority to PCT Application No. PCT/CN2024/103043, filed on Jul. 2, 2024, which in turn claims priority to Chinese Patent Application No. 2023112005927, entitled “METHOD FOR GENERATING A CENTER LINE AND APPARATUS, ELECTRONIC DEVICE, AND STORAGE MEDIUM,” filed with the China National Intellectual Property Administration on Sep. 18, 2023, which are both incorporated by reference in their entirety.

### FIELD OF THE TECHNOLOGY

This application relates to the field of map technologies, and in particular, to a lane center line generation technology.

### BACKGROUND OF THE DISCLOSURE

A lane center line is essential data in a map, and how to automatically generate a lane center line is also one of the key technologies in the industry. When curvatures of tracks of lane lines on two sides of a curved road are inconsistent, a difference between distances from a generated lane center line to the lane lines on the two sides is usually excessively large, and sometimes even the generated lane center line may not be between the two lane lines, that is, the generated lane center line does not conform to a travelling track of a vehicle in a real road network, and the accuracy of the lane center line is relatively low.

### SUMMARY

The following is a brief description of a subject described in detail in this application. This brief description is not intended to limit the protection scope of the claims.

Embodiments of this application provide a method for generating a center line and apparatus, an electronic device, and a storage medium, to improve accuracy of the generated lane center line.

According to an aspect, an embodiment of this application provides a method for generating a center line, performed by an electronic device and including: determining, corresponding to first sampling points on a first lane line of a target lane, projection points of the first sampling point on a second lane line of the target lane as first projection points respectively corresponding to the first sampling points, the first lane line and the second lane line being respectively lane lines on two sides of the target lane; dividing the second lane line into a plurality of first segment lines according to the first projection points, and dividing the first lane line into a plurality of second segment lines according to the first sampling points, the plurality of first segment lines and the plurality of second segment lines being in a one-to-one correspondence; selecting first reference points on the first segment lines and second reference points on the second segment lines according to a same distance proportion, the first reference points and the second reference points being in a one-to-one correspondence; and generating a lane center line of the target lane according to midpoints between groups of the first reference points and the corresponding second reference points.

According to another aspect, an embodiment of this application further provides an electronic device, including a memory and a processor, where the memory has a computer program stored therein, and the processor implements the foregoing method for generating a center line when executing the computer program.

According to another aspect, an embodiment of this application further provides a non-transitory computer-readable storage medium, where the storage medium has a computer program stored therein, and the computer program is executed by a processor to implement the foregoing method for generating a center line.

The embodiments of this application at least have the following beneficial effects. For first sampling points on a first lane line of a target lane, projection points of the first sampling point on a second lane line of the target lane are determined as first projection points respectively corresponding to the first sampling points; and then the second lane line is divided into a plurality of first segment lines according to the first projection points, and the first lane line is divided into a plurality of second segment lines according to the first sampling points, the plurality of second segment lines and the plurality of first segment lines being in a one-to-one correspondence. Therefore, the lane is properly and finely segmented by performing projection based on the first sampling points, so that subsequently when points are selected on the first segment lines and the second segment lines that have a correspondence according to the same distance proportion, a first reference point and a second reference point that are obtained and have a correspondence are located on the same segment. Even when curvatures of tracks of lane lines on two sides of a curved road are inconsistent, because the granularity of the lane is reduced through segmentation, a deviation of a lane center line generated according to a midpoint between the first reference point and the second reference point can be made smaller, thereby effectively reducing the errors of the generated lane center line and improving accuracy of the generated lane center line.

In addition, the lane center line is generated through segmentation in combination with point selection at equal proportions, so that a data processing amount is relatively small, thereby facilitating improvement in efficiency of generating the lane center line.

Other features and advantages of this application are described in the following specification, and partially become apparent from the specification or may be learned from implementation of this application.

### BRIEF DESCRIPTION OF THE DRAWINGS

The accompanying drawings, which are intended to provide a further understanding of technical solutions of this application and constitute a part of the specification, illustrate the technical solutions of this application in combination with embodiments of this application and do not constitute a limitation to the technical solutions of this application.

FIG. 1 is a schematic diagram of a lane center line in a mountain road scenario in related technology.

FIG. 2 is a schematic diagram of a lane center line in a U-turn scenario in related technology.

FIG. 3 is a schematic diagram of an implementation environment according to an embodiment of this application.

FIG. 4 is a flowchart of a method for generating a center line according to an embodiment of this application.

FIG. 5a is a schematic diagram of a lane line of a target lane according to an embodiment of this application.

FIG. 5b is another schematic diagram of a lane line of a target lane according to an embodiment of this application.

FIG. 6 is a schematic diagram of a first sampling point on a first lane line according to an embodiment of this application.

FIG. 7 is a schematic diagram of a first projection point on a second lane line according to an embodiment of this application.

FIG. 8 is a schematic diagram of a first segment line and a second segment line according to an embodiment of this application.

FIG. 9 is another schematic diagram of a first segment line and a second segment line according to an embodiment of this application.

FIG. 10 is a schematic diagram of a process of deleting a second projection point according to an embodiment of this application.

FIG. 11 is a schematic diagram of a process of deleting a first projection point according to an embodiment of this application.

FIG. 12 is a schematic diagram of a reference point pair with an unchanged distance interval during point selection according to an embodiment of this application.

FIG. 13 is a schematic diagram of a reference point pair with a changed distance interval during point selection according to an embodiment of this application.

FIG. 14 is a schematic diagram of a lane center line obtained according to an embodiment of this application.

FIG. 15 is a schematic diagram of a comparison between a lane center line in an embodiment of this application and a lane center line generated in the related technology.

FIG. 16 is a schematic diagram of another comparison between a lane center line in an embodiment of this application and a lane center line generated in the related technology.

FIG. 17 is a schematic diagram showing that a same first projection line and a second lane line have a plurality of first intersection points according to an embodiment of this application.

FIG. 18 is a schematic diagram of a projection point determining model according to an embodiment of this application.

FIG. 19 is a schematic diagram of a distance matrix according to an embodiment of this application.

FIG. 20 is a schematic diagram of intersecting first projection lines according to an embodiment of this application.

FIG. 21 is another schematic diagram of intersecting first projection lines according to an embodiment of this application.

FIG. 22 is a schematic overall flowchart of a method for generating a center line according to an embodiment of this application.

FIG. 23 is a schematic structural diagram of a lane center line generation apparatus according to an embodiment of this application.

FIG. 24 is a partial structural block diagram of a terminal according to an embodiment of this application.

FIG. 25 is a partial structural block diagram of a server according to an embodiment of this application.

### DESCRIPTION OF EMBODIMENTS

To make the objectives, the technical solutions, and the advantages of this application clearer, the following further describes this application in detail with reference to the accompanying drawings and the embodiments. The specific embodiments described herein are for the sole purpose of explaining this application and are not intended to limit this application.

In various specific implementations of this application, when related processing needs to be performed according to data related to a target object characteristic, such as attribute information or an attribute information set of the target object, permission or consent of the target object is first obtained, and acquisition, usage, processing, and the like of the data comply with related laws, regulations, and standards. The target object may be a user. In addition, when target object registration information needs to be obtained in embodiments of this application, individual permission or individual consent of the target object is obtained through a pop-up window or jumping to a confirmation page. After the individual permission or the individual consent of the target object is explicitly obtained, necessary target object-related data for enabling embodiments of this application to operate normally is obtained.

For ease of understanding of the technical solutions provided in embodiments of this application, some key terms used in the embodiments of this application are explained below first.

Lane: It is configured for representing an area on a road or a street for vehicles to travel, is a vehicle travelling area of a particular width, and is usually separated by white or yellow markings. A quantity of lanes may be set according to requirements for a road width and a traffic flow.

Lane center line: It is one of identification lines for dividing a lane, and is usually located at a center position of a lane. That is, a lane center line is a line that is approximately at equal distances to lane lines on left and right sides. The lane center line is a track line for guiding a vehicle to travel in the middle of the lane.

Road segment: In a traffic network, a road segment is a basic element, and is configured for representing each part in a road system. Each road segment has a unique identifier or ID, to be distinguished from other road segments. A road segment usually includes attributes such as start point and end point positions, a length, a road type (for example, an expressway or a city street), a speed limit, and a travelling direction. A plurality of road segments is connected together, so that a complete road can be formed.

A lane center line is necessary data in a map, and how to automatically generate a lane center line is also one of key technologies mainly researched in the industry. In the related technology, a lane center line is usually generated in a manner of selecting points at equal distances. For example, a point is selected at a position that is 2 meters apart from a right lane line; then a track distance between the selected point and a start position of the right lane line is calculated; then a ratio of the track distance to a total track length of the right lane line is calculated; and finally, a point is selected based on a left lane line according to the same ratio, and a center line of a lane is drawn according to a middle point of points selected based on the left and right lane lines. In this manner, a lane center line satisfying a requirement can be rapidly generated in a scenario of approximately parallel and straight roads. However, when curvatures of tracks of lane lines on two sides of a curved road are inconsistent, a difference between distances from a generated lane center line to the lane lines on the two sides is usually excessively large, and even the generated lane center line may not be between the two lane lines, that is, the generated lane center line does not conform to a travelling track of a vehicle in a real road network, and accuracy of the lane center line is relatively low. In view of time complexity and a generation effect, an algorithm in the related technology has a relatively poor effect in a scenario of automatically drawing a lane center line in a map.

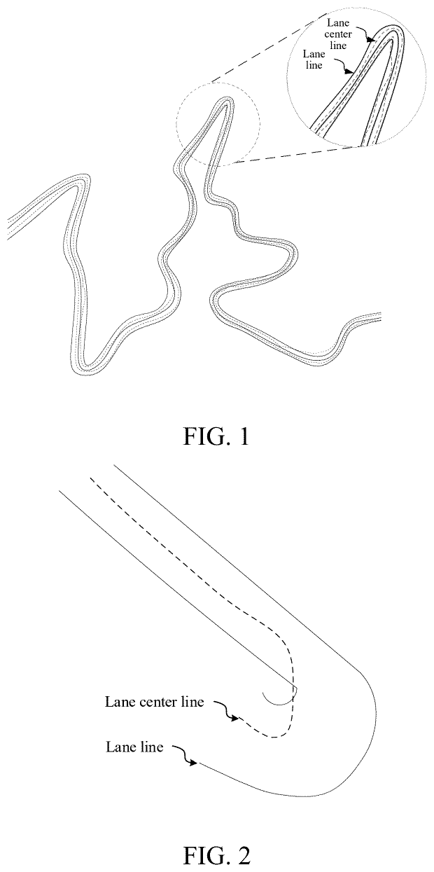

FIG. 1 is a schematic diagram of a lane center line in a mountain road scenario generated in the related technology. In FIG. 1, solid lines indicate lane lines on two sides, and a dashed line indicates a lane center line. Referring to a partial enlarged view in FIG. 1, it can be seen that in a mountain road turn, a lane center line is not in the middle of a lane, or even traverses a lane line. FIG. 2 is a schematic diagram of a lane center line in a U-turn scenario generated in the related technology. In FIG. 2, solid lines indicate lane lines on two sides, and a dashed line indicates a lane center line. It can be seen that in this scenario, track curvatures of lane lines on two sides of the road segment have a relatively large difference, and a lane center line drawn by selecting points at equal distances has a relatively large position deviation. In addition, in the related technology, a center line generated when curvatures of tracks of lane lines on two sides of a curved road are inconsistent is not necessarily smooth and beautiful, needs to be manually calibrated later, and is hardly applicable to an application scenario in which a large quantity of lane center lines are generated.

Based on this, embodiments of this application provide a method for generating a center line and apparatus, an electronic device, and a storage medium, to improve accuracy of the generated lane center line, satisfy a requirement that a difference between distances from a lane center line to lane lines on two sides is within a tolerance range, and satisfy a requirement that the lane center line is smooth and beautiful.

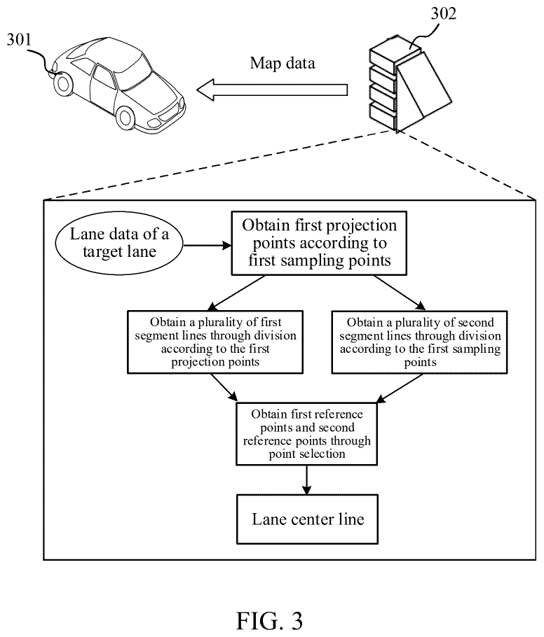

FIG. 3 is a schematic diagram of an implementation environment according to an embodiment of this application. The implementation environment includes a terminal 301 and a data processing server 302. The terminal 301 is connected to the data processing server 302 by using a communication network.

For example, using an example in which the terminal 301 is an in-vehicle terminal, the data processing server 302 obtains lane data of a target lane, and determines, for first sampling points on a first lane line of the target lane, projection points of the first sampling point on a second lane line according to the lane data, to obtain first projection points respectively corresponding to the first sampling points; then divides the second lane line into a plurality of first segment lines according to the first projection points, and divides the first lane line into a plurality of second segment lines according to the first sampling points, the plurality of second segment lines and the plurality of first segment lines being in a one-to-one correspondence; then performs, according to a same distance proportion, point selection on the first segment lines and the second segment lines that have the correspondence, to obtain first reference points on the first segment lines and second reference points on the second segment lines, the first reference points and the second reference points being in a one-to-one correspondence; and finally, generates a lane center line of the target lane according to midpoints between groups of the first reference points and the second reference points that have the correspondence, then constructs map data according to the lane center line, and sends the map data to the terminal 301. The lane is properly and finely segmented by performing projection based on the first sampling points, so that subsequently when points are selected on the first segment lines and the second segment lines that have a correspondence according to the same distance proportion, a first reference point and a second reference point that are obtained are located on the same segment of a target lane. Therefore, even when curvatures of tracks of lane lines on two sides of a curved road are inconsistent, because the granularity of the lane is reduced through segmentation, a deviation of a lane center line generated according to a midpoint between the first reference point and the second reference point that have a correspondence can be made smaller, thereby effectively reducing an error of the generated lane center line and improving accuracy of the generated lane center line.

Correspondingly, the terminal 301 may implement functions such as vehicle navigation, lane departure warning, and assisted driving based on the map data, so that the vehicle keeps travelling on a correct lane, to ensure that the vehicle keeps an appropriate distance with another vehicle, thereby preventing lane departure or collision. In addition, a vehicle position and a travelling direction are detected by using an accurate lane center line, and automatic control is performed, thereby improving performance and reliability of vehicle driving assistance.

The terminal 301 may be a smartphone, a tablet computer, a laptop computer, a desktop computer, a smart speaker, a smartwatch, an in-vehicle terminal, or the like, but is not limited thereto. The terminal 301 and the data processing server 302 may be directly or indirectly connected to each other through wired or wireless communication, which is not limited herein in the embodiments of this application.

The data processing server 302 may be an independent physical server, or a server cluster or distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. In addition, the data processing server 302 may be a node server in a blockchain network.

The method in some embodiments may be applied to various scenarios, which include, but are not limited to, scenarios such as a map, navigation, intelligent transportation, and assisted driving.

The following describes in detail the principle of the method for generating a center line in some embodiments.

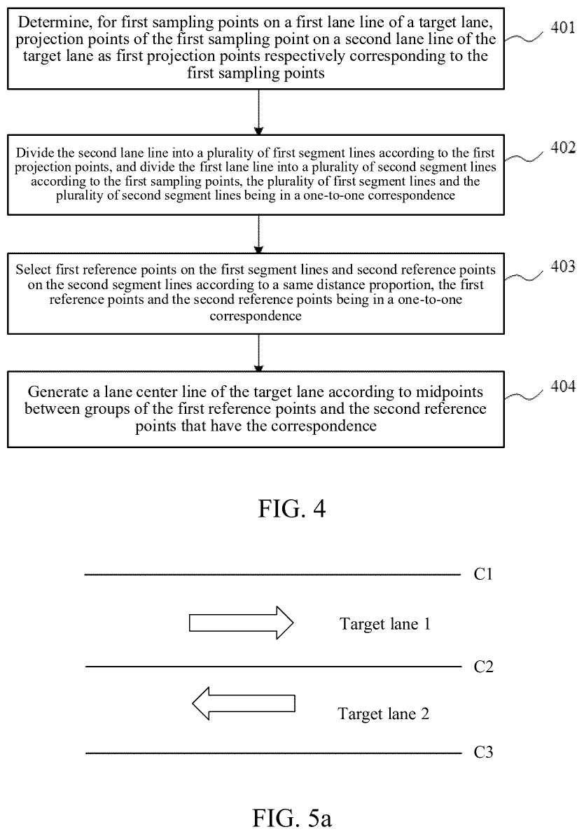

FIG. 4 is a flowchart of a method for generating a center line according to an embodiment of this application. The method for generating a center line may be performed by an electronic device, for example, may be performed by a server, or may be performed by a terminal, or may be performed by a server and a terminal collaboratively. In some embodiments, an example in which the method is performed by a server is configured for description. The method for generating a center line includes but is not limited to the following operation 401 to operation 404.

Operation 401: Determine, for first sampling points on a first lane line of a target lane, projection points of the first sampling point on a second lane line of the target lane as first projection points respectively corresponding to the first sampling points.

In one embodiment, because a lane is generally relatively long, the lane may be segmented according to road segments to obtain lane segments, a lane center line of each lane segment is drawn one by one, and then the lane center lines of the lane segments are connected to obtain a total lane center line. A lane corresponding to the foregoing lane segment is referred to as a target lane herein. In some embodiments, the target lane may alternatively be a complete lane. This is not limited in some embodiments.

In one embodiment, the server may obtain lane data corresponding to the target lane from road data. The road data includes geometrical information of a road such as a shape, a length, and a width of the road. The lane data includes positions of lane lines on two sides of the target lane that are obtained through calculation according to the geometrical information of the road. The lane line related information of the target lane may be obtained according to the lane data. The road data herein may be data obtained through ground measurement, remote sensing, connection to a geographic information system, or receiving from an automobile sensor. The ground measurement refers to performing on-site measurements on a road by using a measurement tool, to obtain the geometrical information and other related data of the road. The remote sensing refers to obtaining image data of a road by using a remote sensing technology such as photography, a satellite imagery, or an unmanned aerial vehicle, and then extracting road information through image processing and a computer vision algorithm. Data connection to the existing geographic information system may alternatively be performed, to acquire road data such as a topographic map, city planning data, and a satellite image. In addition, the road data may also be uploaded by the in-vehicle terminal. Correspondingly, the road data may be uploaded by the in-vehicle terminal after being acquired by an acquiring device mounted on the vehicle, where the acquiring device may be a radar device such as a camera, a laser radar, or a millimeter-wave radar; or the road data may be acquired by a remote sensor disposed on a remote sensing platform such as a remote sensing vehicle, a ship, or an aircraft, be transmitted to the in-vehicle terminal, and then be uploaded by the in-vehicle terminal, or may be acquired by an intelligent vehicle infrastructure cooperative system, be transmitted to the in-vehicle terminal and then be uploaded by the in-vehicle terminal, or the like. This embodiment of the present disclosure does not limit a manner of obtaining the road data.

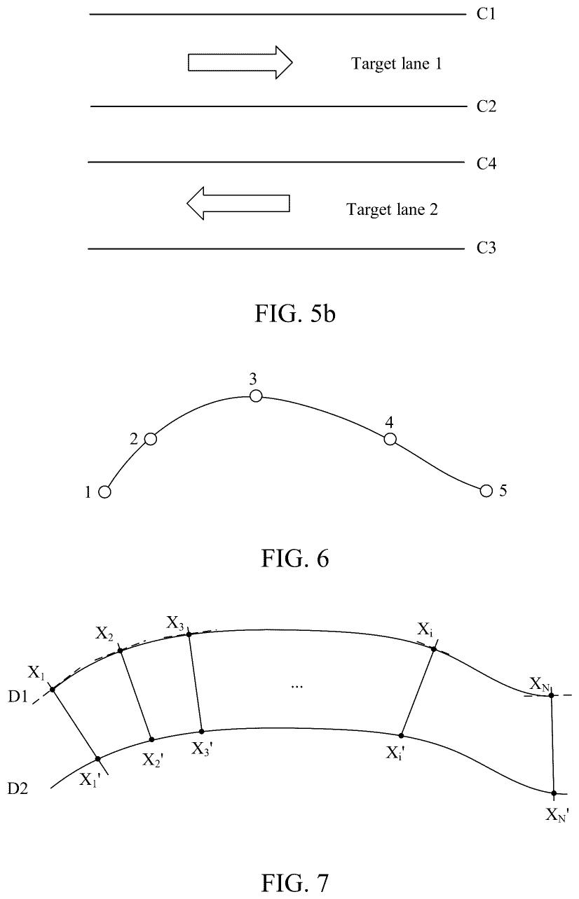

In one embodiment, the first lane line and the second lane line are respectively lane lines on two sides of the target lane. FIG. 5a is a schematic diagram of a lane line of a target lane according to an embodiment of this application. Along a travelling direction, each target lane includes lane lines on left and right sides. For ease of description, the two lane lines are respectively recorded as a first lane line and a second lane line. For example, a left lane line may be used as the first lane line, and a right lane line may be used as the second lane line. Referring to FIG. 5a, a target lane 1 and a target lane 2 are shown. The target lane 1 and the target lane 2 are adjacent lanes that have opposite directions. The target lane 1 and the target lane 2 share a lane line C2. Therefore, the target lane 1 has a first lane line C1 and a second lane line C2, a first lane line of the target lane 2 is C3, and a second lane line of the target lane 2 is C2. FIG. 5b is another schematic diagram of a lane line of a target lane according to an embodiment of this application. Referring to FIG. 5b, a target lane 1 and a target lane 2 are shown. The target lane 1 and the target lane 2 are adjacent lanes that have opposite directions. The target lane 1 and the target lane 2 are spaced apart by a particular distance. Therefore, the target lane 1 has a first lane line C1 and a second lane line C2, and the target lane 2 has a first lane line C3 and a second lane line C4.

In one embodiment, a sampling point may be at a position on a lane line at which a curvature changes, and a start point and an end point of the lane line may also be used as sampling points of the lane line. Therefore, first sampling points include a start point and an end point of a first lane line and a point at which a curvature changes. FIG. 6 is a schematic diagram of a first sampling point on a first lane line according to an embodiment of this application. It is assumed that a first lane line in FIG. 6 has three positions at which curvatures change. Therefore, plus a start point and an end point, the first lane line has five first sampling points, which are respectively a first sampling point 1, a first sampling point 2, a first sampling point 3, a first sampling point 4, and a first sampling point 5.

In one embodiment, the process of determining, for first sampling points on a first lane line of a target lane, projection points of the first sampling point on a second lane line of the target lane, to obtain corresponding first projection points specifically includes: generating first tangent lines of the first lane line according to the first sampling points on the first lane line of the target lane, and then generating first projection lines perpendicular to the first tangent lines based on the first sampling points, and determining the first projection points corresponding to the first sampling points according to first intersection points of the first projection lines and the second lane line of the target lane. On a road or a map, a process in which a point is extended or mapped to another line along a direction is referred to as projection. In this embodiment, a first sampling point on a first lane line is mapped to a second lane line through projection. Specifically, the determining a projection point of a first sampling point on a first lane line on a second lane line is extending the first sampling point on the first lane line in a direction perpendicular to the first lane line on which the first sampling point is located, until intersecting with the second lane line of the target lane, to obtain the corresponding projection point. The corresponding position points on the first lane line and the second lane line on the target lane may be obtained through projection.

In one embodiment, FIG. 7 is a schematic diagram of determining a first projection point on a second lane line according to an embodiment of this application. In FIG. 7, a target lane includes a first lane line D1 and a second lane line D2. It is assumed that the first lane line D1 includes N first sampling points. The first sampling points are represented as {X₁, . . . , X_{N}}. The first sampling point X₁ and the first sampling point X_{N} represent a start point and an end point of the first lane line D1, and other first sampling points are points on the first lane line D1 whose curvatures change. A first tangent line of the first lane line is generated at a position of each first sampling point, then a first projection line perpendicular to the corresponding first tangent line is generated at the position of the first sampling point, and the first projection line is prolonged until intersecting with the second lane line. The intersection point is recorded as a first intersection point. In FIG. 7, first intersection points correspond to the first sampling points, and the first intersection points are represented as {X₁′, . . . , X_{N}′}. Finally, first projection points obtained by performing projection onto the second lane line of the target lane are determined according to the first intersection points.

Therefore, in the foregoing manner, the first projection point corresponding to each first sampling point on the first lane line on the second lane line is determined, to ensure accuracy of the determined first projection point. Subsequently, the first lane line is divided based on each first sampling point, and the second lane line is divided based on each first projection point, to ensure that the segment lines obtained through division accurately correspond, facilitating improvement in accuracy of a finally determined lane center line.

In the foregoing process, projection is performed onto the second lane line of the target lane from each first sampling point on the first lane line of the target lane, to obtain the first projection point. Next, a corresponding lane line is segmented by using the first sampling points and the first projection points.

Operation 402: Divide the second lane line into a plurality of first segment lines according to the first projection points, and divide the first lane line into a plurality of second segment lines according to the first sampling points, the plurality of first segment lines and the plurality of second segment lines being in a one-to-one correspondence.

In one embodiment, first projection lines corresponding to the first projection points have a projection sequence. The projection sequence is referred to as projection line sorting, that is, the first projection lines are arranged in order. The projection line sorting herein may be obtained by performing sorting according to distances between corresponding first sampling points and a start point of the first lane line, or by performing projection in ascending order of distances between first sampling points and a start point of the first lane line. In this case, the projection line sorting of the first projection lines may be obtained by performing sorting according to generation time. An order of the first projection points corresponding to the first sampling points is obtained based on the projection line sorting of the first projection lines respectively corresponding to the first sampling points, the second lane line is sequentially segmented in the order of the first projection points along the travelling direction of the target lane, to obtain a plurality of first segment lines, and the first lane line is sequentially segmented along the travelling direction of the target lane according to an order of the first sampling points, to obtain second segment lines respectively corresponding to the first segment lines. In this manner, the two lane lines of the target lane are divided and the segment lines correspond to each other.

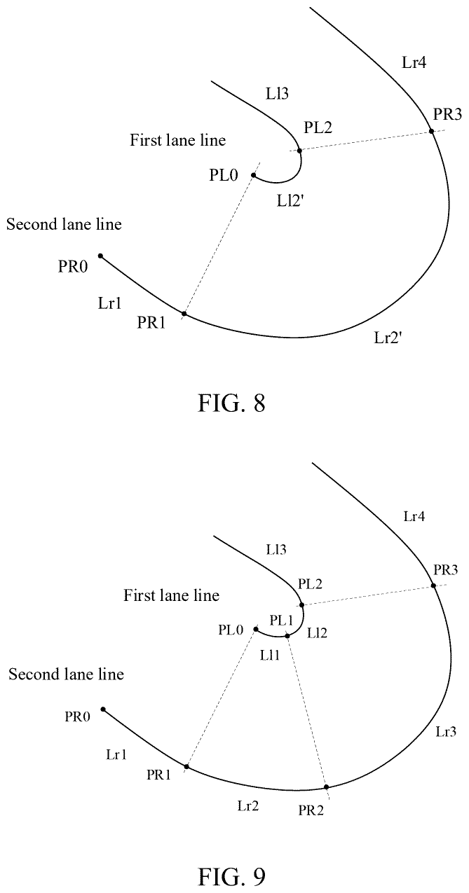

In one embodiment, FIG. 8 is a schematic diagram of a first segment line and a second segment line according to an embodiment of this application. A first lane line in FIG. 8 includes two first sampling points, which are respectively PL0 and PL2, where the first sampling point PL0 is a start point of the first lane line, and the first sampling point PL2 is a point on the first lane line at which a curvature changes. In this case, projection is sequentially performed according to distances between the first sampling points and the start point, to generate a first projection line of each first sampling point, and two first projection points on a second lane line are respectively obtained according to first intersection points of the first projection line and the second lane line. The first projection points are sequentially PR1 and PR3. Assuming that a start point of the second lane line is PR0 according to the travelling direction of the target lane, the second lane line is sliced according to the first projection points to obtain three first segment lines, which are sequentially represented as a line segment Lr1 between PR0 and PR1, a line segment Lr2′ between PR1 and PR3, and a line segment Lr4 formed by the remaining part of the second lane line after PR3. Correspondingly, the first lane line is sequentially segmented along the travelling direction of the target lane according to an order of the first sampling points, to obtain second segment lines respectively corresponding to the three first segment lines, which are sequentially represented as the first sampling point PL0, a line segment L12′ between PL0 and PL2, and a line segment L13 formed by the remaining part of the first lane line after PL2. There may be a second segment line formed by a single point. In addition, the target lane is segmented by using the first segment lines and the second segment lines that correspond to each other, to obtain corresponding lane segments, and sampling of the lane segments includes two types: an approximate triangular sector and an approximate quadrangle.

A correspondence between a first segment line and a second segment line in FIG. 8 is shown in Table 1.

TABLE 1
Correspondence between a first segment line
and a second segment line in FIG. 8

| Shape of lane segment | First lane line | Second lane line |
|---|---|---|
| Approximate triangular | First sampling point PL0 | Line segment Lr1 |
| sector | | |
| Approximate quadrangle | Line segment Ll2′ | Line segment Lr2′ |
| Approximate quadrangle | Line segment Ll3 | Line segment Lr4 |

In one embodiment, to subdivide two lane boundary lines of the target lane more properly, the first lane line is reversely divided according to a curvature change situation of the second lane line. Therefore, the process of dividing the second lane line into a plurality of first segment lines according to the first projection points, and dividing the first lane line into a plurality of second segment lines according to the first sampling points specifically includes: determining, for second sampling points between two adjacent first projection points on the second lane line, projection points of the second sampling points on the first lane line, to obtain second projection points corresponding to the second sampling points; then dividing the second lane line into the plurality of first segment lines along a travelling direction of the target lane according to the first projection points and the second sampling points; and finally dividing the first lane line into the plurality of second segment lines along the travelling direction according to the first sampling points and the second projection points.

In one embodiment, there is a second sampling point between adjacent first projection points on the second lane line. Similarly, the second sampling point includes a start point or an end point of the second lane line, or a point on the second lane line at which a curvature changes. A second sampling point is selected between every two adjacent first projection points according to an order of the first projection points, a second tangent line of the second lane line is generated according to the selected second sampling point, then a second projection line perpendicular to the second tangent line is generated at a position of the second sampling point, the second projection line is prolonged until intersecting with the first lane line, where the intersection point is recorded as a second intersection point, and a second projection point corresponding to the second sampling point on the first lane line is determined according to the second intersection point. In this case, the second lane line includes the first projection points and the second sampling points, and the first projection points and the second sampling points are sequentially arranged. Therefore, the second lane line is sequentially divided into a plurality of first segment lines along the travelling direction of the target lane and an order of the first projection points and the second sampling points. In this case, the first lane line includes the second projection points and the first sampling points, and the second projection points and the first sampling points are sequentially arranged. Therefore, the first lane line is sequentially divided into a plurality of second segment lines along the travelling direction and an order of the second projection points and the first sampling points.

In one embodiment, FIG. 9 is another schematic diagram of a first segment line and a second segment line according to an embodiment of this application. FIG. 9 is subdivided based on FIG. 8. As shown in FIG. 9, a first lane line includes two first sampling points, which are respectively PL0 and PL2. Projection is sequentially performed according to distances between the first sampling points and the start point, to generate a first projection line of each first sampling point, and two first projection points on a second lane line are respectively obtained according to first intersection points of the first projection line and the second lane line. Sequentially, the first projection points are respectively PR1 and PR3. One second sampling point PR2 exists between the first projection points PR1 and PR3, the second sampling point PR2 is a point at which a curvature changes on the second lane line, and it is assumed that a start point of the second lane line is PR0 according to the travelling direction. In this case, the second lane line is sequentially divided into a plurality of first segment lines along the travelling direction according to the start point PR0, the first projection point PR1, the second sampling point PR2, and the first projection point PR3, which are sequentially represented as a line segment Lr1 between PR0 and PR1, a line segment Lr2 between PR1 and PR2, a line segment Lr3 between PR1 and PR2, and a line segment Lr4 formed by the remaining part of the second lane line after PR3. In this case, the first lane line is projected based on the second sampling point PR2, to obtain a second projection point PL1. In this case, the first lane line is sequentially divided into a plurality of second segment lines along the travelling direction according to the first sampling point PL0, the second projection point PL1, and the first sampling point PL2, to obtain four second segment lines corresponding to the first segment lines, which are sequentially represented as the first sampling point PL0, a line segment Ll1 between PL0 and PL1, a line segment Ll2 between PL1 and PL2, and a line segment Ll3 formed by the remaining part of the first lane line after PL2.

A correspondence between a first segment line and a second segment line in FIG. 9 is shown in Table 2.

TABLE 2
Correspondence between a first segment line
and a second segment line in FIG. 9

| Shape of lane segment | First lane line | Second lane line |
|---|---|---|
| Approximate triangular | First sampling point PL0 | Line segment Lr1 |
| sector | | |
| Approximate quadrangle | Line segment Ll1 | Line segment Lr2 |
| Approximate quadrangle | Line segment Ll2 | Line segment Lr3 |
| Approximate quadrangle | Line segment Ll3 | Line segment Lr4 |

In the foregoing process, first, forward division is performed on the second lane line by using a first projection point corresponding to a first sampling point on the first lane line and a second sampling point on the second lane line, and then, reverse division is performed on the first lane line by using a second projection point corresponding to the second sampling point on the second lane line and the first sampling point on the first lane line. Through a process of forward division and reverse division, a correspondence between the first lane line and the second lane line may be better established, thereby implementing more proper division of a target lane.

In one embodiment, in a process of dividing the second segment lines, to improve reliability and properness of division of the second segment lines, the second projection points need to be screened. Therefore, the process of dividing the first lane line into the plurality of second segment lines along the travelling direction according to the first sampling points and the second projection points specifically includes: obtaining, for each of the second projection points, first position coordinates of the second projection point and second position coordinates of two target sampling points on the first lane line, the two target sampling points being first sampling points respectively corresponding to two first projection points adjacent to the second sampling point corresponding to the second projection point; determining a position relationship between the second projection point and the two target sampling points according to the first position coordinates and the second position coordinates; deleting the second projection point when the position relationship indicates that the second projection point is located beyond the two target sampling points; and then dividing the first lane line into the plurality of second segment lines along the travelling direction according to the first sampling points and a remaining second projection point.

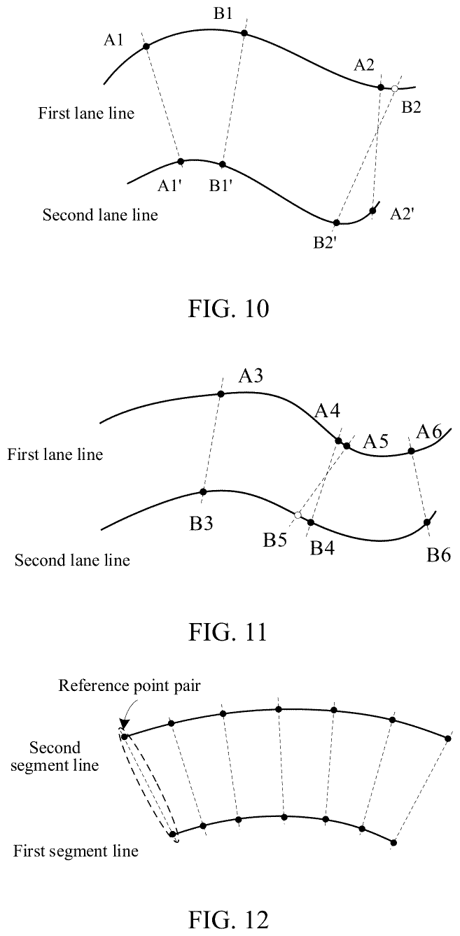

In one embodiment, after the second projection points are obtained, validity screening needs to be performed according to positions of the second projection points on the first lane line. FIG. 10 is a schematic diagram of a process of deleting a second projection point according to an embodiment of this application. Two adjacent first sampling points on a first lane line are respectively A1 and A2, and first projection points corresponding to the two adjacent first sampling points on a second lane line are respectively A1′ and A2′. Two second sampling points B1′ and B2′ are included between the first projection points A1′ and A2′, a second projection point corresponding to the second sampling point B1′ on the first lane line is B1, and a second projection point corresponding to the second sampling point B2′ on the first lane line is B2. In this case, two target sampling points associated with the second projection point B1 are A1 and A2, and two target sampling points associated with the second projection point B2 are also A1 and A2. In a screening process, first, first position coordinates of each of the second projection points B1 and B2 and second position coordinates of each of the corresponding two target sampling points A1 and A2 are obtained, then a position relationship between each second projection point and the two target sampling points is determined according to the first position coordinates and the second position coordinates, and when the position relationship indicates that the second projection point is located beyond the two adjacent first sampling points, the second projection point is deleted. It may be learned from FIG. 10 that, the second projection point B2 is located beyond the target sampling points A1 and A2, and the second projection point B1 is located within the target sampling points A1 and A2. Therefore, the second projection point B2 needs to be deleted. In this case, the first lane line may be divided into second segment lines corresponding to the first segment lines along the travelling direction according to the first sampling points A1 and A2 and the remaining second projection point B1.

If a second projection point is deleted, when the second lane line is divided into the first segment lines, the second sampling point corresponding to the deleted second projection point also needs to be removed, so that the first segment lines correspond to the second segment lines.

In one embodiment, when the first projection points corresponding to the first sampling points on the first lane line on the second lane line are determined, validity screening of the first projection points may be performed according to positions in a manner similar to the foregoing manner. FIG. 11 is a schematic diagram of a process of deleting a first projection point according to an embodiment of this application. For example, first projection points corresponding to first sampling points A3, A4, A5 and A6 are sequentially B3, B4, B5, and B6. Position information of each first projection point is obtained, and two target projection points of the first projection point are selected according to an order of the first sampling points. The target projection points are first projection points respectively corresponding to two adjacent first sampling points of a first sampling point corresponding to the first projection point. For example, target projection points of the first projection point B5 are respectively B4 and B6. It may be learned from FIG. 11 that the first projection point B5 is located beyond the target projection points B4 and B6. Therefore, the first projection point B5 needs to be deleted. After the first projection point B5 is deleted, validity screening is performed. The second lane line is divided into the plurality of first segment lines along a travelling direction according to the remaining first projection points.

Therefore, in the foregoing manner, validity screening is performed on the second projection points on the first lane line and the first projection points on the second lane line, then division of a plurality of second segment lines is performed according to the first sampling points on the first lane line and the remaining second projection points, and division of a plurality of first segment lines is performed according to the second sampling points on the second lane line and the remaining first projection points, which can ensure reliability and properness of division of the second segment lines and the first segment lines.

In the foregoing process, the first lane line and the second lane line of the target lane are segmented, to obtain the first segment lines and the second segment lines that correspond to each other, and then, obtaining reference points of the lane center line by using the segment lines is described.

Operation 403: Select first reference points on the first segment lines and second reference points on the second segment lines according to a same distance proportion.

It can be learned that quantities of the first reference points and the second reference points are the same, and the first reference points and the second reference points are in a one-to-one correspondence.

In one embodiment, a distance proportion is configured for representing a proportion of a distance between a reference point and one end of a segment line in a length of the segment line. For example, a distance between the first reference point and a start point of the first segment line is defined as a first start point distance, a distance between the first reference point and an end point of the first segment line is defined as a first end point distance, a distance between the second reference point and a start point of the second segment line is defined as a second start point distance, and a distance between the second reference point and an end point of the second segment line is defined as a second end point distance. Correspondingly, for the first segment line, the distance proportion herein may be the first start point distance/the length of the first segment line, or the first end point distance/the length of the first segment line, and for the second segment line, the distance proportion herein may be the second start point distance/the length of the second segment line, or the second end point distance/the length of the second segment line.

In one embodiment, point selection is performed according to the same distance proportion, that is, a distance proportion of the first reference point is the same as a distance proportion of the corresponding second reference point. Specifically, the process of performing, according to a same distance proportion, point selection on the first segment lines and the second segment lines that have the correspondence specifically includes: determining target segment lines in the first segment lines and the second segment lines, and performing point selection on the target segment lines according to a preset distance interval; and then determining a distance proportion according to the distance interval, and performing point selection on other segment lines different from the target segment lines in the first segment lines and the second segment lines according to the distance proportion.

In one embodiment, if the target segment line is the first segment line, the target segment line corresponds to the second segment line, and if the target segment line is the second segment line, the target segment line corresponds to the first segment line. It is assumed that the target segment line is the first segment line, and the foregoing point selection process includes: First, points are selected from the start point on the first segment line according to a preset distance interval. The preset distance interval herein may be set according to a specific scenario. For example, the distance interval is 1 m. After the distance interval is obtained, a distance proportion may be calculated. For example, a total length of the first segment line is 10 m, and a total length of the second segment line is 5 m. In this case, the preset distance interval is 1 m, and a distance proportion of selecting a point for the first time may be 1/10=0.1. A first first reference point is selected at a distance of 10 m*0.1=1 m from a start point of the first segment line, and then a point selection position is calculated according to 5 m*0.1=0.5 m on the second segment line. In this case, a first second reference point is selected at a position that is 0.5 m away from a start point of the second segment line. Assuming that the preset distance interval is unchanged, when a point is selected for the second time, a distance between the second first reference point and the start point of the first segment line is 2 m. In this case, a distance proportion is (1+1)/10=0.2, and a second second reference point needs to be selected at a position that is 5 m*0.2=1 m away from the start point of the second segment line. The rest can be deduced by analogy. First reference points are evenly selected on the first segment line, corresponding second reference points are evenly selected on the second segment line, and a first reference point and a corresponding second reference point form a reference point pair. FIG. 12 is a schematic diagram of a reference point pair with an unchanged distance interval during point selection according to an embodiment of this application. It can be seen that in FIG. 12, first reference points are evenly distributed on a first segment line, and similarly, second reference points are evenly distributed on a second segment line.

In one embodiment, assuming that the preset distance interval is unchanged, alternatively, the quantity of selected points on the target segment line may be calculated according to the distance interval, and the first segment line and the second segment line are evenly divided according to the quantity of selected points. Distance proportions of selecting points each time are the same. In this manner, point selection efficiency is improved.

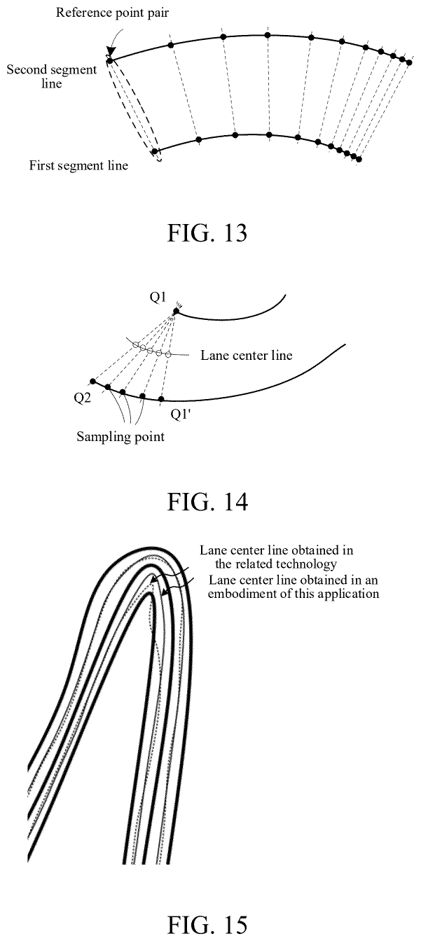

In one embodiment, the preset distance interval may be dynamically and adaptively adjusted each time a point is selected. That is, the distance interval may change each time a point is selected. In this case, each time a point is selected, a distance proportion needs to be calculated according to a current distance interval, to ensure that the reference point selected on the target segment line changes with the distance interval, and synchronously changes with the reference point on the first segment line or the second segment line corresponding to the target segment line. Setting a dynamic distance interval and calculating a distance proportion each time a point is selected has the following advantages: First, a distance proportion is calculated according to a current distance interval, so that an adaptive sampling policy can be implemented. Adaptive sampling is performed according to a specific situation, to avoid a problem of an excessively large or small quantity of sampling points. For example, in a case of a segment line having a relatively small curvature change or a straight line segment, a relatively large distance interval may be configured for reducing the quantity of sampling points, thereby improving point selection efficiency. In a key area such as a relatively large curvature change or a curved lane, a relatively small distance interval may be configured for increasing density of sampling points, so as to select a more accurate reference point pair, thereby further improving accuracy of a lane center line. In addition, the distance proportion is recalculated each time a point is selected, which can ensure that the reference point on the target segment line and the reference point on the first segment line or the second segment line corresponding to the target segment line synchronously change, thereby helping reduce accumulation of deviations and errors, and can maintain a spatial relationship between the two segment lines, ensure continuity and consistency of division, and improve accuracy and stability of selecting a reference point pair. FIG. 13 is a schematic diagram of a reference point pair with a changed distance interval during point selection according to an embodiment of this application. Assuming that a distance interval gradually decreases with the quantity of times of selecting points, reference points become denser with the quantity of times of selecting points. It can be seen that in FIG. 13, along a travelling direction, first reference points are increasingly concentrated on a first segment line. Similarly, along the travelling direction, second reference points are also increasingly concentrated on a second segment line.

In one embodiment, the process of determining target segment lines in the first segment lines and the second segment lines specifically includes: determining the first segment lines as the target segment lines when a length of the first segment lines is greater than a length of the second segment lines; or determining the second segment lines as the target segment lines when a length of the first segment lines is less than a length of the second segment lines; or determining the first segment lines or the second segment lines as the target segment lines when a length of the first segment lines is equal to a length of the second segment lines.

The objective of the foregoing process is to select the longer one of the first segment line and the second segment line as the target segment line. In this manner, lengths of the first segment line and the second segment line are compared, and the target segment line is determined according to a specific scenario. A selection rule is flexible, and can adapt to segment lines of different lengths. No matter whether the first segment line is longer, the second segment line is longer, or the lengths of the first segment line and the second segment line are equal, selection may be performed according to a specific situation. The target segment line can be selected only by comparing lengths of the first segment line and the second segment line. The operation is simple and clear, and a complex calculation process and an additional judging condition can be avoided, thereby reducing a calculation amount in a lane center line generation process and improving generation efficiency. In addition, the target segment line is determined according to a length difference between the first segment line and the second segment line. When lengths of the two segment lines are significantly different, a longer one is selected as the target segment line to better cover an entire road, thereby improving accuracy of a result of the reference point pair.

Operation 404: Generate a lane center line of the target lane according to midpoints between groups of the first reference points and the second reference points that have the correspondence.

Referring to Table 1 and Table 2, after the target lane is segmented, shapes of lane segments include two types: an approximate triangular sector and an approximate quadrangle. In one embodiment, when a first projection point corresponding to a start point of a first lane line matches a start point of a second lane line, it indicates that there is no lane segment in the shape of an approximate triangular sector. In this case, after the first reference point and the second reference point are obtained, coordinates of the first reference point and the second reference point are averaged, to obtain midpoint coordinates of the two points, and the midpoint coordinates are used as a point on the center line of the target lane. The process is repeated. The first reference point and the second reference point of the next adjacent reference point pair are selected, midpoint coordinates of the two points are calculated, to obtain a series of midpoint coordinates of the lane center line, and the generated midpoint coordinates are connected in sequence, to form the lane center line of the target lane.

To further improve generation accuracy of the lane center line, in one embodiment, in a process of generating a lane center line for a lane segment in the shape of an approximate triangular sector, the process of generating a lane center line of the target lane according to midpoints between groups of the first reference points and the second reference points that have the correspondence specifically includes: determining, when the first projection point corresponding to the start point of the first lane line does not match the start point of the second lane line, third segment lines on the second lane line according to the start point of the second lane line and the first projection point corresponding to the start point of the first lane line; performing point selection on the third segment lines, to obtain third reference points; and generating the lane center line of the target lane according to midpoints between groups of the first reference points and the second reference points that have the correspondence, and midpoints between the third reference points and the start point of the first lane line.

In the foregoing embodiment, if the first projection point corresponding to the start point of the first lane line does not match the start point of the second lane line, it indicates that after the target lane is segmented, there is a lane segment in the shape of an approximate triangular sector. Therefore, more reference points need to be selected on a curved side of the triangular sector to assist in generating a lane center line. FIG. 14 is a schematic diagram of a lane center line according to an embodiment of this application. In FIG. 14, a start point of a first lane line is Q1, a first projection point corresponding to the start point on a second lane line is Q1′, and a start point of the second lane line is Q2. Therefore, a third segment line is determined on the second lane line according to the start point Q2 of the second lane line and the first projection point Q1′ corresponding to the start point Q1 of the first lane line. The third segment line is represented as Q2Q1′. Next, points are selected on the third segment line Q2Q1′. As shown in FIG. 14, a plurality of points is selected on the third segment line Q2Q1′ to serve as third reference points. Meanwhile, the start point Q2 of the second lane line may also be used as a third reference point. In this case, the lane segment includes a reference point pair formed by a first reference point and a second reference point, and a reference point pair formed by a third reference point and the start point of the first lane line. Then, a midpoint corresponding to each reference point pair is calculated, to obtain coordinates of a plurality of midpoints. Next, as shown in FIG. 14, the plurality of midpoints is connected to form a lane center line of the segment of target lane.

In one embodiment, the process of performing point selection on the third segment lines, to obtain third reference points specifically includes: performing point selection on the third segment lines according to the preset distance interval, to obtain the third reference points; or using midpoints of the third segment lines as the third reference points. In this embodiment, when a point on the third segment line is selected as a third reference point, a preset distance interval may be set. The distance interval may be fixed, or may be dynamically adjusted. Alternatively, in view of a requirement for calculation efficiency, the distance interval does not need to be calculated, and a midpoint of the third segment line is directly selected as a sampling point.

Therefore, in the foregoing manner, when a first projection point corresponding to a start point of a first lane line does not match a start point of a second lane line, a third segment line is further determined on the second lane line according to a start point of the second lane line and the first projection point corresponding to the start point of the first lane line, third reference points are sampled in the third segment line according to a particular point selection rule, and then a lane center line is determined with reference to midpoints between the third reference points and the start point of the first lane line. In this way, completeness of the determined lane center line, that is, complete correspondence with the target lane, may be ensured, thereby improving accuracy of the determined lane center line.

In some embodiments, after the lane center line of each lane segment is obtained by using the foregoing process, all lane center lines are connected, to obtain the lane center line of the target lane. The lane center line is generated through segmentation in combination with point selection at equal proportions, so that a data processing amount is relatively small, thereby facilitating improvement in efficiency of generating the lane center line. In addition, after the lane center line is obtained, the lane center line may be further smoothed.

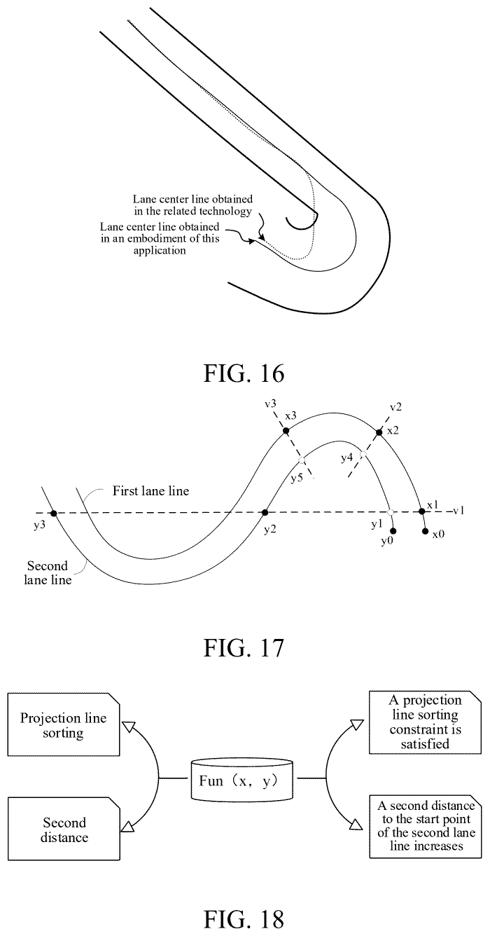

FIG. 15 and FIG. 16 are respectively schematic diagrams of comparisons between a lane center line generated in an embodiment of this application and a lane center line generated in the related technology.

In FIG. 15 or FIG. 16, a thick solid line indicates a first lane line or a second lane line of a target lane, and a lane center line is included between each first lane line and a second lane line corresponding to the first lane line. A thin solid line indicates a lane center line generated in an embodiment of this application, and a dashed line indicates a lane center line generated in the related technology. It may be learned from FIG. 15 and FIG. 16 that, on a straight road segment having a first lane line and a second lane line that are approximately parallel, a difference between a lane center line generated by using an embodiment of this application and a lane center line generated in the related technology is relatively small, and the lane center line generated by using some embodiments may be relatively close to a middle travelling track and have a relatively small deviation. However, at a place where turning occurs or a curvature of a lane line greatly changes, due to a change of a road geometry, the method for generating a center line in some embodiments can better capture details of areas where a curvature changes and turning occurs. Therefore, the lane center line generated in some embodiments better conforms to a middle travelling track, a position deviation of the lane center line is smaller, and an automation degree of a lane center line generation process is relatively high. However, in the related technology, a position deviation of a lane center line at a turning place is relatively large, a requirement of manually correcting a lane center line is relatively high, and generally, a workload of more than 3% is involved, leading to a large workload in a lane center line generation process and high labor costs.

In some embodiments, for first sampling points on a first lane line of a target lane, projection points of the first sampling point on a second lane line of the target lane are determined as first projection points respectively corresponding to the first sampling points; and then the second lane line is divided into a plurality of first segment lines according to the first projection points, and the first lane line is divided into a plurality of second segment lines according to the first sampling points, the plurality of second segment lines and the plurality of first segment lines being in a one-to-one correspondence. Therefore, the lane is properly and finely segmented by performing projection based on the first sampling points, so that subsequently when points are selected on the first segment lines and the second segment lines that have a correspondence according to the same distance proportion, a first reference point and a second reference point that are obtained and have a correspondence are located on the same segment. Even when curvatures of tracks of lane lines on two sides of a curved road are inconsistent, because the granularity of the lane is reduced through segmentation, a deviation of a lane center line generated according to a midpoint between the first reference point and the second reference point can be made smaller, thereby effectively reducing an error of the generated lane center line and improving accuracy of the generated lane center line. In addition, the lane center line is generated through segmentation in combination with point selection at equal proportions, so that a data processing amount is relatively small, thereby facilitating improvement in efficiency of generating the lane center line.

In one embodiment, in a serpentine road segment such as an S-curved mountain road, relative positions between a first lane line and a second lane line may change multiple times. In this case, the same first projection line may have a plurality of first intersection points with the second lane line. Therefore, the process of determining the first projection points corresponding to the first sampling points according to first intersection points of the first projection lines and the second lane line specifically includes: first determining respective first distances between the first sampling points and a start point of the first lane line, then determining projection line sorting of the first projection lines in ascending order of the first distances, then determining second distances between the first intersection points and a start point of the second lane line, and sequentially determining target intersection points from the first intersection points respectively corresponding to the first projection lines according to the projection line sequence, second distances of the target intersection points sequentially increasing according to the projection line sequence; and finally determining the target intersection points as the first projection points corresponding to the first sampling points.

FIG. 17 is a schematic diagram showing that a same first projection line and a second lane line have a plurality of first intersection points according to an embodiment of this application. A target lane in FIG. 17 is in an S-shape, a start point of a first lane line is x0, and first sampling points include x1, x2, and x3. Correspondingly, a first projection line of the first sampling point x1 is v1, a first projection line of the first sampling point x2 is v2, and a first projection line of the first sampling point x3 is v3. The first projection line v1 and a second lane line have a plurality of first intersection points, which are respectively {y1, y2, y3}. The first projection line v2 and the second lane line have one first intersection point y4, and the first projection line v3 and the second lane line have one first intersection point y5. In this scenario, the process of determining the first projection points corresponding to the first sampling points according to first intersection points of the first projection lines and the second lane line is as follows: First, first distances respectively between the first sampling points x1, x2, and x3 and the start point x0 of the first lane line are determined. The first distances herein are not straight-line distances between the first sampling points and the start point of the first lane line, but are distances between the first sampling points and the start point of the first lane line on the first lane line. In FIG. 17, the first distance between the first sampling point x1 and the start point x0 of the first lane line is d1, the first distance between the first sampling point x2 and the start point x0 of the first lane line is d2, and the first distance between the first sampling point x3 and the start point x0 of the first lane line is d3. A magnitude relationship between the first distances is: first distance d1<first distance d2<first distance d3. Therefore, in ascending order of the first distances, projection line sorting of the plurality of first projection lines is determined as: first projection line v1→first projection line v2→first projection line v3.

Next, a second distance between each first intersection point and a start point of the second lane line is determined. Assuming that the start point of the second lane line is y0, second distances between the first intersection points y1, y2, y3, y4, and y5 and the start point y0 of the second lane line are determined. The second distances herein are not straight-line distances between the first intersection points and the start point of the second lane line, but are distances between the first intersection points and the start point of the second lane line on the second lane line. In FIG. 17, the second distance between the first intersection point y1 and the start point y0 of the second lane line is k1, the second distance between the first intersection point y2 and the start point y0 of the second lane line is k2, the second distance between the first intersection point y3 and the start point y0 of the second lane line is k3, the second distance between the first intersection point y4 and the start point y0 of the second lane line is k4, and the second distance between the first intersection point y5 and the start point y0 of the second lane line is k5. A magnitude relationship between the second distances is: second distance k1<second distance k4<second distance k5<second distance k2<second distance k3.

Then, target intersection points are sequentially determined from the first intersection points respectively corresponding to the first projection lines according to the projection line sequence. There is only one first intersection point between each of the first projection line v2 and the first projection line v3 and the second lane line. Therefore, the first intersection point y4 is a target intersection point of the first projection line v2, and the first intersection point y5 is a target intersection point of the first projection line v3. Because there is a plurality of first intersection points {y1, y2, y3} between the first projection line v1 and the second lane line, a target intersection point of the first projection line v1 needs to be determined from the first intersection points {y1, y2, y3}. Second distances of target intersection points need to satisfy a rule of sequentially increasing according to projection line sorting. Therefore, according to the projection line sequence, the second distance of the target intersection point of the first projection line v1 needs to be less than a second distance k4 of the target intersection point y4 of the first projection line v2, and the second distance k4 of the target intersection point y4 of the first projection line v2 needs to be less than a second distance k5 of the target intersection point y5 of the first projection line v3. According to the ascending order of the second distances, it can be learned that only the second distance k1<the second distance k4. Therefore, the target intersection point of the first projection line v1 is determined as the first intersection point y1 corresponding to the second distance k1. Finally, the target intersection point is determined as the first projection point corresponding to the first sampling point x1. Therefore, the first projection point y1 corresponding to the first sampling point x1, the first projection point y4 corresponding to the first sampling point x2, and the first projection point y5 corresponding to the first sampling point x3 are obtained.

Through the foregoing process, a first distance between a first sampling point and a start point of a first lane line, and a second distance between a first intersection point and a start point of a second lane line are considered, a target intersection point corresponding to each first sampling point is determined in the serpentine road segment according to the projection line sequence, to generate a target lane line conforming to a lane layout.

Similarly, in a serpentine road segment, in the process of performing projection, in a second lane line, onto a first lane line from a second sampling point between two adjacent first projection points to obtain a second projection point, there may also be a plurality of second intersection points between the same second projection line and the first lane line. In this case, the process of determining the second projection points corresponding to the second sampling points according to second intersection points of the second projection lines and the first lane line of the target lane specifically includes: first determining respective third distances between second sampling points and the start point of the second lane line, then determining second projection line sorting of the second projection lines in ascending order of the third distances, then determining fourth distances between the second intersection points and the start point of the first lane line, sequentially determining second target intersection points from the second intersection points respectively corresponding to the second projection lines according to the second projection line sorting, fourth distances of the second target intersection points sequentially increasing according to the second projection line sorting; and finally determining the second target intersection points as the second projection points corresponding to the second sampling points.

In one embodiment, the process of sequentially determining target intersection points from the first intersection points respectively corresponding to the first projection lines according to the projection line sequence specifically includes: constructing a distance matrix of the first intersection points by using the second distances as matrix elements according to the projection line sequence; inputting the distance matrix into a projection point determining model, traversing the distance matrix by using the projection point determining model, and determining a target matrix element sequence in the distance matrix, the target matrix element sequence including the plurality of second distances sequentially increasing according to the projection line sequence; and sequentially determining, according to a position of the target matrix element sequence in the distance matrix, the target intersection points in the plurality of first intersection points respectively corresponding to the first projection lines.

First, projection line sorting constructed in ascending order of the first distances is obtained, and then a distance matrix is constructed. A matrix element of the distance matrix represents the second distance between each first intersection point and the start point of the second lane line, and each row of the matrix corresponds to the second distance of each first intersection point under one first projection line. If a first projection line corresponds to only one first intersection point, a quantity of matrix elements in the row is 1. Next, the distance matrix is inputted into the projection point determining model, and the projection point determining model is configured for determining, based on the distance matrix, the target intersection point corresponding to each first projection line.

FIG. 18 is a schematic diagram of a projection point determining model according to an embodiment of this application. The projection point determining model is expressed as: Fun (x, y)=a continuously increasing longest sub-sequence, where x represents projection line sorting, y represents a second distance between each first intersection point and a start point of a second lane line, known quantities in the projection point determining model include the projection line sorting and the second distance, and the following two result constraint conditions are included: 1) projection line sorting constraint is satisfied; and 2) a second distance to the start point of the second lane line increases. When determining the target intersection point, the projection point determining model traverses the distance matrix, and sequentially selects, according to the projection line sequence, first intersection points satisfying a rule that values of corresponding matrix elements gradually increase as target intersection points, to obtain a continuously increasing longest sub-sequence.

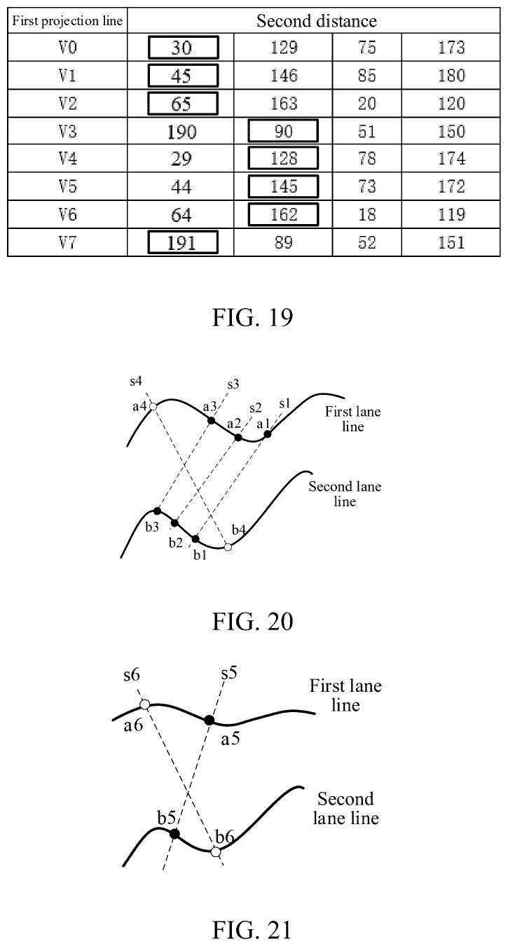

In one embodiment, FIG. 19 is a schematic diagram of a distance matrix according to an embodiment of this application. FIG. 19 includes eight first projection lines, and each first projection line has four intersection points with a second lane line. According to projection line sorting, second distances of four first intersection points of a first projection line V0 are respectively: 30, 129, 75, and 173; second distances of four first intersection points of a first projection line V1 are respectively: 45, 146, 85, and 180; second distances of four first intersection points of a first projection line V2 are respectively: 65, 163, 20, and 120; second distances of four first intersection points of a first projection line V3 are respectively: 190, 90, 51, and 150; second distances of four first intersection points of a first projection line V4 are respectively: 29, 128, 78, and 174; second distances of four first intersection points of a first projection line V5 are respectively: 44, 145, 73, and 172; second distances of four first intersection points of a first projection line V6 are respectively: 64, 162, 18, and 119; second distances of four first intersection points of a first projection line V7 are respectively: 191, 89, 52, and 151. Therefore, the distance matrix in FIG. 19 is represented as:

$$[ \begin{matrix}30 & 129 & 75 & 173 \\ 45 & 146 & 85 & 180 \\ 65 & 163 & 20 & 120 \\ 190 & 90 & 51 & 150 \\ 29 & 128 & 78 & 174 \\ 44 & 145 & 73 & 172 \\ 64 & 162 & 18 & 119 \\ 191 & 89 & 52 & 151\end{matrix} ]$$

The foregoing distance matrix is inputted into a projection point determining model, and a target intersection point of each first projection line is selected row by row. The following needs to be satisfied: According to the projection line sequence, a second distance of a target intersection point of a former first projection line is less than a second distance of a target intersection point of a latter first projection line. Therefore, during selection, each matrix element in the distance matrix needs to be comprehensively considered. In FIG. 19, a second distance corresponding to a target intersection point selected for the first projection line V0 is 30, a second distance corresponding to a target intersection point selected for the first projection line V1 is 45, a second distance corresponding to a target intersection point selected for the first projection line V2 is 65, a second distance corresponding to a target intersection point selected for the first projection line V3 is 90, a second distance corresponding to a target intersection point selected for the first projection line V4 is 128, a second distance corresponding to a target intersection point selected for the first projection line V5 is 145, a second distance corresponding to a target intersection point selected for the first projection line V6 is 162, and a second distance corresponding to a target intersection point selected for the first projection line V7 is 191. It can be learned that the foregoing obtained target matrix element sequence is: {30, 45, 65, 90, 128, 145, 162, 191}, where the target matrix element sequence includes a plurality of second distances sequentially increasing based on the projection line sorting. Finally, the target intersection points in the plurality of first intersection points corresponding to the first projection lines are sequentially determined according to a position of the target matrix element sequence in the distance matrix.

In one embodiment, if quantities of first intersection points corresponding to first projection lines in the distance matrix are inconsistent, the distance matrix may be completed to reduce calculation complexity. According to a quantity of matrix elements included in a row corresponding to a largest quantity of first intersection points, other rows are completed. During completion, a missing position may be filled with a maximum value of the row.

In the foregoing process, a relationship between the projection line sorting and the second distance between each first projection point and the second lane line is considered by using the projection point determining model, so that the target intersection point can be more accurately determined. In addition, the projection point determining model can automatically process the distance matrix and determine the target intersection point without manual intervention, which can reduce manpower costs required in a conventional manual correction process of a lane center line, avoid manually performing complex correction and adjustment, improve work efficiency, and reduce risks of manual operations and human mistakes.

In one embodiment, a plurality of first projection lines may intersect with each other. In this case, to improve properness of selecting first projection points, first projection points corresponding to the intersecting first projection lines need to be screened, to reduce inaccuracy or confusion caused by the intersection. Therefore, the process of determining the first projection points corresponding to the first sampling points according to first intersection points of the first projection lines and the second lane line specifically includes: determining, when intersecting first projection lines exist, two first sampling points located on the two sides in first sampling points respectively corresponding to the intersecting first projection lines as a first to-be-processed point and a second to-be-processed point along the travelling direction of the target lane; deleting, from the first intersection points of the first projection lines and the second lane line according to a quantity of sampling points between the first to-be-processed point and the second to-be-processed point, a first intersection point corresponding to the first to-be-processed point or the second to-be-processed point; and determining the first projection points according to remaining first intersection points.

If there are intersecting first projection lines, the first to-be-processed point and the second to-be-processed point are selected according to the travelling direction of the target lane, and when first intersection points are calculated, a first intersection point corresponding to the first to-be-processed point or the second to-be-processed point is deleted according to a quantity of first sampling points between the two to-be-processed points, to remove an intersection relationship between the first projection lines, and further determine first projection points corresponding to the first sampling points according to the remaining first intersection points.

In one embodiment, the process of deleting, from the first intersection points of the first projection lines and the second lane line according to a quantity of sampling points between the first to-be-processed point and the second to-be-processed point, a first intersection point corresponding to the first to-be-processed point or the second to-be-processed point specifically includes: deleting, from the first intersection points of the first projection lines and the second lane line when the quantity of sampling points between the first to-be-processed point and the second to-be-processed point is greater than or equal to a quantity threshold, a first intersection point corresponding to the second to-be-processed point; or deleting, from the first intersection points of the first projection lines and the second lane line when the quantity of sampling points between the first to-be-processed point and the second to-be-processed point is less than the quantity threshold, a first intersection point corresponding to the first to-be-processed point or the second to-be-processed point.

The quantity threshold may be 0 or 1. For example, the quantity threshold is 1. When a quantity of first sampling points between the first to-be-processed point and the second to-be-processed point is 3, in this case, the quantity 3 of the first sampling points is greater than the quantity threshold 1, and multiple first sampling points exist near the second to-be-processed point. If only the first to-be-processed point is removed, the intersection relationship between the first projection lines may not be canceled. Therefore, the first intersection point corresponding to the second to-be-processed point may be deleted. When a quantity of first sampling points between the first to-be-processed point and the second to-be-processed point is 0, it indicates that there is no other first sampling point between the first to-be-processed point and the second to-be-processed point. In this case, the quantity 0 of the first sampling points is less than the quantity threshold 1, and there is no first sampling point between the first to-be-processed point or the second to-be-processed point. It can be known that the first to-be-processed point and the second to-be-processed point are adjacent first sampling points. In this case, the intersection relationship of the first projection lines can be removed by randomly selecting and deleting one of the first intersection points.

FIG. 20 is a schematic diagram of intersecting first projection lines according to an embodiment of this application. It can be known from FIG. 20 that, a first lane line includes four first sampling points {a1, a2, a3, a4}, corresponding first projection lines are s1, s2, s3, and s4, a first intersection point of the first sampling point a1 and a second lane line through the first projection line s1 is b1, a first intersection point of the first sampling point a2 and the second lane line through the first projection line s2 is b2, a first intersection point of the first sampling point a3 and the second lane line through the first projection line s3 is b3, and a first intersection point of the first sampling point a4 and the second lane line through the first projection line s4 is b4. The first projection line s4 intersects with each of the first projection line s1, the first projection line s2, and the first projection line s3. Therefore, according to the foregoing process, because intersecting first projection lines exist, two first sampling points located on the two sides in first sampling points corresponding to the intersecting first projection lines are sequentially determined as a first to-be-processed point and a second to-be-processed point along the travelling direction of the target lane. In FIG. 20, the determined first to-be-processed point is a1, and the determined second to-be-processed point is a4. Then, the quantity of first sampling points between the first to-be-processed point a1 and the second to-be-processed point a4 is calculated. It can be learned that two first sampling points {a2, a3} are included between the first to-be-processed point a1 and the second to-be-processed point a4. Therefore, the quantity of sampling points is 2. Assuming that a quantity threshold is 1, the quantity 2 of sampling points is greater than the quantity threshold 1. Referring to FIG. 20, if the first intersection point b1 corresponding to the first to-be-processed point a1 and the first projection line s1 corresponding to the first intersection point b1 are removed, there is still an intersection relationship between the remaining first projection line s2, first projection line s3, and first projection line s4. Therefore, the first intersection point b4 corresponding to the second to-be-processed point a4 needs to be deleted from the first intersection points {b1, b2, b3, b4} of the first projection lines {s1, s2, s3, s4} and the second lane line of the target lane. Because the first intersection point b4 is removed, the first projection line s4 corresponding to the first intersection point b4 is removed. In this case, there is no intersection relationship between the remaining first projection line s1, first projection line s2, and first projection line s3. Then, the first projection points {b1, b2, b3} corresponding to the first sampling points are determined according to the remaining first intersection points {b1, b2, b3}.

If some first projection lines still have an intersection relationship after the first intersection point corresponding to the first to-be-processed point or the second to-be-processed point is removed according to the foregoing process, the first to-be-processed point and the second to-be-processed point are reselected, and the intersection relationship continues to be removed according to the foregoing process.

FIG. 21 is another schematic diagram of intersecting first projection lines according to an embodiment of this application. It can be known from FIG. 21 that, a first lane line includes two first sampling points {a5, a6}, corresponding first projection lines are s5 and s6, a first intersection point of the first sampling point a5 and a second lane line through the first projection line s5 is b5, and a first intersection point of the first sampling point a6 and the second lane line through the first projection line s6 is b6. The first projection line s5 intersects with the first projection line s6. Therefore, according to the foregoing process, because intersecting first projection lines exist, two first sampling points respectively located on the two sides in first sampling points corresponding to the intersecting first projection lines are sequentially determined as a first to-be-processed point and a second to-be-processed point along the travelling direction of the target lane. In FIG. 21, the determined first to-be-processed point is a5, and the determined second to-be-processed point is a6. Then, the quantity of first sampling points between the first to-be-processed point a5 and the second to-be-processed point a6 is calculated. It can be learned that there is no other first sampling point between the first to-be-processed point a5 and the second to-be-processed point a6. Therefore, the quantity of sampling points is 0. Assuming that a quantity threshold is 1, the quantity 0 of sampling points is less than the quantity threshold 1. Referring to FIG. 21, the first intersection point b5 corresponding to the first to-be-processed point a5 or the first intersection point b6 corresponding to the first to-be-processed point a6 is randomly removed, and there is no intersection relationship for the remaining first projection line s5 or first projection line s6. Therefore, only one of the first intersection point b5 and the first intersection point b6 need to be removed. First projection points corresponding to the first sampling points are determined according to the remaining first intersection point b5 or first intersection point b6.

Through the foregoing process, the first intersection point affected by the intersection relationship between the first projection lines is removed, so that the properness of selecting the first projection point can be improved, thereby improving the properness of performing lane segmentation subsequently on the target lane.

Similarly, in the process of performing projection, in a second lane line, onto a first lane line from a second sampling point between two adjacent first projection points to obtain a second projection point, there may also be intersecting second projection lines. In this case, the process of determining the second projection points corresponding to the second sampling points according to second intersection points of the second projection lines and the first lane line of the target lane specifically includes: sequentially determining, when intersecting second projection lines exist, two second sampling points located on the two sides in second sampling points respectively corresponding to the intersecting second projection lines as a third to-be-processed point and a fourth to-be-processed point along the travelling direction of the target lane, and then deleting, from the second intersection points of the second projection lines and the first lane line according to a quantity of sampling points between the third to-be-processed point and the fourth to-be-processed point, a second intersection point corresponding to the third to-be-processed point or the fourth to-be-processed point; and then determining the second projection points corresponding to the second sampling points according to a remaining second intersection point. In addition, the process of deleting, from the second intersection points of the second projection lines and the first lane line according to a quantity of sampling points between the third to-be-processed point and the fourth to-be-processed point, a second intersection point corresponding to the third to-be-processed point or the fourth to-be-processed point specifically includes: deleting, from the second intersection points of the second projection lines and the first lane line when the quantity of sampling points between the third to-be-processed point and the fourth to-be-processed point is greater than or equal to a quantity threshold, a second intersection point corresponding to the fourth to-be-processed point; or deleting, from the second intersection points of the second projection lines and the first lane line when the quantity of sampling points between the third to-be-processed point and the fourth to-be-processed point is less than the quantity threshold, a second intersection point corresponding to the third to-be-processed point or the fourth to-be-processed point.

Through the foregoing multiple measures, in an aspect, a suitable first projection point and a suitable second sampling point are selected on the second lane line, so as to properly divide the second lane line into a plurality of first segment lines along the travelling direction of the target lane according to the first projection point and the second sampling point; and in another aspect, a suitable first sampling point and a suitable second projection point are selected on the first lane line, so as to properly divide the first lane line into second segment lines corresponding to the first segment lines along the travelling direction of the target lane according to the first sampling point and the second projection point. Fine-grained division is performed on the target lane by using the first segment lines and the second segment lines that are obtained through proper division, to obtain lane segments, so that details of areas where a curvature changes and turning occurs can be better captured, a lane center line generated according to the lane segments better conforms to a travelling track, and a position deviation of the lane center line is smaller.

In some embodiments, after related data of the lane center line is obtained, the related data of the lane center line is sent to a navigation engine of a high-precision map, so that a travelable lane can be precisely positioned, and efficiency of making the high-precision map can be effectively improved. The precise lane center line can provide data support for an assisted driving decision in a travelling process, to prevent the vehicle from exceeding a range of the target lane when travelling, thereby reducing a probability that a traffic accident occurs in the travelling process, and improving safety of driving assistance.

The following describes in detail the principle of the method for generating a center line in some embodiments.

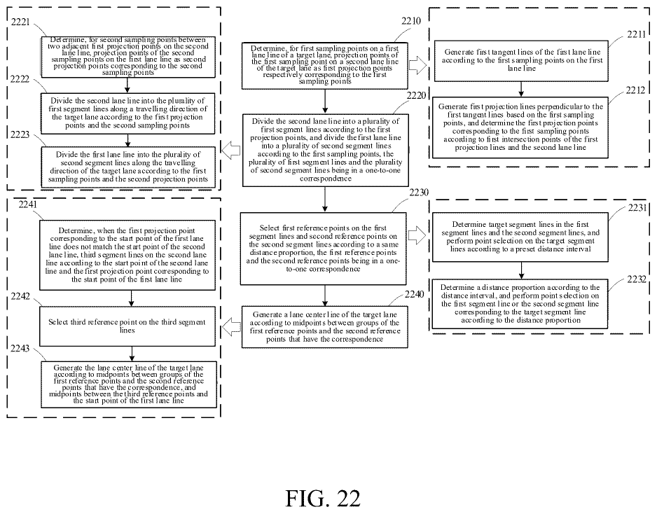

FIG. 22 is a schematic overall flowchart of a method for generating a center line according to an embodiment of this application.

Operation 2210: Determine, for first sampling points on a first lane line of a target lane, projection points of the first sampling point on a second lane line of the target lane as first projection points respectively corresponding to the first sampling points.

Lane data corresponding to the target lane may be obtained from road data. The road data includes geometrical information of a road such as a shape, a length, and a width of the road. The lane data includes positions of lane lines on two sides of the target lane that are obtained through calculation according to the geometrical information of the road. The lane line related information of the target lane may be obtained according to the lane data. In some embodiments, the road data may be data obtained through ground measurement, remote sensing, connection to a geographic information system, or receiving from an automobile sensor. In addition, the first lane line and the second lane line are respectively lane lines on two sides of the target lane. A sampling point is at a position on a lane line at which a curvature changes, and a start point and an end point of the lane line may also be used as sampling points of the lane line.

In some embodiments, the determining, for first sampling points on a first lane line of a target lane, projection points of the first sampling point on a second lane line of the target lane as first projection points respectively corresponding to the first sampling points specifically includes:

Operation 2211: Generate first tangent lines of the first lane line according to the first sampling points on the first lane line.

Operation 2212: Generate first projection lines perpendicular to the first tangent lines based on the first sampling points, and determine the first projection points corresponding to the first sampling points according to first intersection points of the first projection lines and the second lane line.

On a road or a map, a process in which a point is extended or mapped to another line along a direction is referred to as projection. The position points having a correspondence on the first lane line and the second lane line on the target lane may be obtained through projection. In this embodiment, a first sampling point on a first lane line is mapped to a second lane line through projection. In addition, first projection lines corresponding to the first projection points obtained through projection have a projection sequence. The projection sequence is referred to as projection line sorting. In some embodiments, the projection line sorting may be obtained by performing sorting according to distances between corresponding first sampling points and a start point of the first lane line, or may be obtained by performing sorting according to generation time of the first projection lines. Specifically, operation 2212 of performing projection onto the second lane line of the target lane for each first sampling point on the first lane line of the target lane is extending the first sampling point on the first lane line in a direction perpendicular to the first lane line on which the first sampling point is located, until intersecting with the second lane line of the target lane, to obtain a first intersection point, and obtaining a corresponding first projection point based on the first intersection point.

In one embodiment, in some special road segments, relative positions between a first lane line and a second lane line may change multiple times. In this case, the same first projection line may have a plurality of first intersection points with the second lane line. Therefore, in operation 2212, the process of determining the first projection points corresponding to the first sampling points according to first intersection points of the first projection lines and the second lane line specifically includes: first determining respective first distances between the first sampling points and a start point of the first lane line, then determining projection line sorting of the first projection lines in ascending order of the first distances, then determining second distances between the first intersection points and a start point of the second lane line, and sequentially determining target intersection points from the first intersection points respectively corresponding to the first projection lines according to the projection line sequence, second distances of the target intersection points sequentially increasing according to the projection line sequence; and finally determining the target intersection points as the first projection points corresponding to the first sampling points.

In addition, the process of sequentially determining target intersection points from the first intersection points respectively corresponding to the first projection lines according to the projection line sequence specifically includes: constructing a distance matrix of the first intersection points by using the second distances as matrix elements according to the projection line sequence; inputting the distance matrix into a projection point determining model, traversing the distance matrix by using the projection point determining model, and determining a target matrix element sequence in the distance matrix, the target matrix element sequence including the plurality of second distances sequentially increasing according to the projection line sequence; and sequentially determining, according to a position of the target matrix element sequence in the distance matrix, the target intersection points in the plurality of first intersection points respectively corresponding to the first projection lines.

Through the foregoing process, a first distance between a first sampling point and a start point of a first lane line, and a second distance between a first intersection point and a start point of a second lane line are considered, a target intersection point corresponding to each first sampling point is determined in the serpentine road segment according to the projection line sequence, to generate a target lane line conforming to a lane layout.

In one embodiment, a plurality of first projection lines may intersect with each other. In this case, to improve properness of selecting first projection points, first projection points corresponding to the intersecting first projection lines need to be screened, to avoid inaccuracy caused by intersection of the first projection lines. Therefore, in operation 2212, the process of determining the first projection points corresponding to the first sampling points according to first intersection points of the first projection lines and the second lane line specifically includes: sequentially determining, when intersecting first projection lines exist, two first sampling points located on the two sides in first sampling points respectively corresponding to the intersecting first projection lines as a first to-be-processed point and a second to-be-processed point along the travelling direction of the target lane; deleting, from the first intersection points of the first projection lines and the second lane line according to a quantity of sampling points between the first to-be-processed point and the second to-be-processed point, a first intersection point corresponding to the first to-be-processed point or the second to-be-processed point; and determining the first projection points according to remaining first intersection points.

In one embodiment, the process of deleting, from the first intersection points of the first projection lines and the second lane line according to a quantity of sampling points between the first to-be-processed point and the second to-be-processed point, a first intersection point corresponding to the first to-be-processed point or the second to-be-processed point specifically includes: deleting, from the first intersection points of the first projection lines and the second lane line when the quantity of sampling points between the first to-be-processed point and the second to-be-processed point is greater than or equal to a quantity threshold, a first intersection point corresponding to the second to-be-processed point; or deleting, from the first intersection points of the first projection lines and the second lane line when the quantity of sampling points between the first to-be-processed point and the second to-be-processed point is less than the quantity threshold, a first intersection point corresponding to the first to-be-processed point or the second to-be-processed point.

Through the foregoing process, the first intersection point affected by the intersection relationship between the first projection lines is removed, so that the properness of selecting the first projection point can be improved, thereby improving the properness of performing lane segmentation subsequently on the target lane.

In the foregoing process, projection is performed onto the second lane line of the target lane from each first sampling point on the first lane line of the target lane, to obtain the corresponding first projection point.

Operation 2220: Divide the second lane line into a plurality of first segment lines according to the first projection points, and divide the first lane line into a plurality of second segment lines according to the first sampling points, the plurality of first segment lines and the plurality of second segment lines being in a one-to-one correspondence.

An order corresponding to the first projection points is obtained based on the projection line sorting of the first projection lines of the first sampling points, the second lane line is sequentially segmented in the order of the first projection points along the travelling direction of the target lane, to obtain a plurality of first segment lines, and then the first lane line is sequentially segmented along the travelling direction of the target lane according to an order of the first sampling points, to create second segment lines corresponding to the first segment lines. In this manner, the two lane lines of the target lane are divided and the segment lines correspond to each other.

In one embodiment, to subdivide two lane boundary lines of the target lane more properly, the first lane line is reversely divided according to a curvature change situation of the second lane line. Therefore, the process of dividing the second lane line into a plurality of first segment lines according to the first projection points, and dividing the first lane line into a plurality of second segment lines according to the first sampling points specifically includes:

Operation 2221: Determine, for second sampling points between two adjacent first projection points on the second lane line, projection points of the second sampling points on the first lane line as second projection points corresponding to the second sampling points.

There is a second sampling point between adjacent first projection points on the second lane line. Similarly, the second sampling point includes a start point or an end point of the second lane line, or a point on the second lane line at which a curvature changes. A second sampling point is selected between two adjacent first projection points according to an order of the first projection points.

Operation 2222: Divide the second lane line into the plurality of first segment lines along a travelling direction of the target lane according to the first projection points and the second sampling points.

A second tangent line of the second lane line is generated according to the generated second sampling point, then a second projection line perpendicular to the second tangent line is generated at a position of the second sampling point, the second projection line is prolonged until intersecting with the first lane line, where the intersection point is recorded as a second intersection point, and a second projection point corresponding to the second sampling point on the first lane line is determined according to the second intersection point. In this case, the second lane line includes the first projection points and the second sampling points, and the first projection points and the second sampling points are sequentially arranged. Therefore, the second lane line is sequentially divided into a plurality of first segment lines along the travelling direction of the target lane and an order of the first projection points and the second sampling points.

Operation 2223: Divide the first lane line into the plurality of second segment lines along the travelling direction of the target lane according to the first sampling points and the second projection points.

The first lane line includes the second projection points and the first sampling points, and the second projection points and the first sampling points are sequentially arranged. Therefore, the first lane line is sequentially divided into a plurality of second segment lines along the travelling direction of the target lane and an order of the second projection points and the first sampling points.

In addition, in a process of dividing the second segment lines, to improve reliability and properness of division of the second segment lines, the second projection points need to be screened. Therefore, in operation 2223, the process of dividing the first lane line into the plurality of second segment lines along the travelling direction according to the first sampling points and the second projection points specifically includes: obtaining, for each of the second projection points, first position coordinates of the second projection point and second position coordinates of two target sampling points on the first lane line, the two target sampling points being first sampling points respectively corresponding to two first projection points adjacent to the second sampling point corresponding to the second projection point; determining a position relationship between the second projection point and the two target sampling points according to the first position coordinates and the second position coordinates; deleting the second projection point when the position relationship indicates that the second projection point is located beyond the two target sampling points; and dividing the first lane line into the plurality of second segment lines along the travelling direction according to the first sampling points and a remaining second projection point.

In one embodiment, considering that in some special road segments, in the process of performing projection, in a second lane line, onto a first lane line from a second sampling point between two adjacent first projection points to obtain a second projection point, there may also be a plurality of second intersection points between the same second projection line and the first lane line, the second intersection points may also be screened according to the process of determining the target intersection point when the same first projection line and the second lane line have a plurality of first intersection points in operation 2212.

In one embodiment, considering that in some special road segments, in the process of performing projection, in a second lane line, onto a first lane line from a second sampling point between two adjacent first projection points to obtain a second projection point, there may also be intersecting second projection lines, the second projection points may also be screened according to the process of deleting the first projection point when intersecting first projection lines exist in operation 2212.

In some embodiments, forward division is performed on the second lane line based on the first sampling points on the first lane line, and then reverse division is performed on the first lane line based on the second sampling points on the second lane line. Through a process of forward division and reverse division, a correspondence between the first lane line and the second lane line may be better established, thereby implementing more proper division of a target lane.

Operation 2230: Perform, according to a same distance proportion, point selection on the first segment lines and the second segment lines that have the correspondence, to obtain first reference points on the first segment lines and second reference points on the second segment lines, the first reference points and the second reference points being in a one-to-one correspondence.

In one embodiment, in operation 2230, the process of performing, according to a same distance proportion, point selection on the first segment lines and the second segment lines that have the correspondence specifically includes:

Operation 2231: Determine target segment lines in the first segment lines and the second segment lines, and perform point selection on the target segment lines according to a preset distance interval.

If the target segment line is the first segment line, the target segment line corresponds to the second segment line, and if the target segment line is the second segment line, the target segment line corresponds to the first segment line.

Operation 2232: Determine a distance proportion according to the distance interval, and perform point selection on the first segment line or the second segment line corresponding to the target segment line according to the distance proportion.

In one embodiment, it is assumed that the target segment line is the first segment line. Points are selected from the start point on the first segment line according to a preset distance interval. The preset distance interval may be set according to a specific scenario. After the distance interval is obtained, a distance proportion is calculated, the first first reference point is selected on the first segment line according to the distance interval. Then, on the second segment line, a point selection position is calculated according to the distance proportion, and the first second reference point is selected. In this case, the first reference point and the second reference point form a reference point pair. The rest can be deduced by analogy. First reference points are evenly selected on the first segment line, and second reference points are evenly selected on the second segment line, to form a plurality of reference point pairs.

In one embodiment, the preset distance interval may be dynamically and adaptively adjusted each time a point is selected. That is, the distance interval may change each time a point is selected. In this case, each time a point is selected, a distance proportion needs to be calculated according to a current distance interval, to ensure that the reference point selected on the target segment line changes with the distance interval, and synchronously changes with the reference point on the first segment line or the second segment line corresponding to the target segment line.

In one embodiment, the process of determining target segment lines in the first segment lines and the second segment lines specifically includes: determining the first segment lines as the target segment lines when a length of the first segment lines is greater than a length of the second segment lines; or determining the second segment lines as the target segment lines when a length of the first segment lines is less than a length of the second segment lines; or determining the first segment lines or the second segment lines as the target segment lines when a length of the first segment lines is equal to a length of the second segment lines. The objective of the foregoing process is to select the longer one of the first segment line and the second segment line as the target segment line. The target segment line can be selected only by comparing lengths of the first segment line and the second segment line. The operation is simple and clear, and a complex calculation process and an additional judging condition can be avoided, thereby reducing a calculation amount in a lane center line generation process and improving generation efficiency. In addition, the target segment line is determined according to a length difference between the first segment line and the second segment line. When lengths of the two segment lines are significantly different, a longer one is selected as the target segment line to better cover an entire road, thereby improving accuracy of a result of the reference point pair.

Operation 2240: Generate a lane center line of the target lane according to midpoints between groups of the first reference points and the second reference points that have the correspondence.

In one embodiment, when a first projection point corresponding to a start point of a first lane line matches a start point of a second lane line, coordinates of the first reference point and the second reference point are averaged after the first reference point and the second reference point are obtained, to obtain midpoint coordinates of the two points, and the midpoint coordinates are used as a point on the center line of the target lane. The process is repeated. A next group of a first reference point and a second reference point that have a correspondence is selected, midpoint coordinates of the two points are calculated, to obtain a series of midpoint coordinates of the lane center line, and the generated midpoint coordinates are connected in sequence, to form the lane center line of the target lane.

To further improve generation accuracy of the lane center line, in one embodiment, in a process of generating a lane center line for a lane segment in the shape of an approximate triangular sector, in operation 2240, the generating a lane center line of the target lane according to midpoints between groups of the first reference points and the second reference points that have the correspondence specifically includes:

Operation 2241: Determine, when the first projection point corresponding to the start point of the first lane line does not match the start point of the second lane line, third segment lines on the second lane line according to the start point of the second lane line and the first projection point corresponding to the start point of the first lane line.

Operation 2242: Perform point selection on the third segment lines, to obtain third reference points.

Operation 2243: generating the lane center line of the target lane according to midpoints between groups of the first reference points and the second reference points that have the correspondence, and midpoints between the third reference points and the start point of the first lane line.

In one embodiment, the process of performing point selection on the third segment lines, to obtain third reference points specifically includes: performing point selection on the third segment lines according to the preset distance interval, to obtain the third reference points; or using midpoints of the third segment lines as the third reference points. In this embodiment, when a point on the third segment line is selected as a sampling point, a preset distance interval may be set. The distance interval may be fixed, or may be dynamically adjusted. Alternatively, in view of a requirement for calculation efficiency, a midpoint of the third segment line may be directly selected as a sampling point. Then, the sampling points are connected to form a lane center line of the segment of target lane.

In some embodiments, after the lane center line of each lane segment is obtained by using the foregoing process, all lane center lines are connected, to obtain the lane center line of the target lane. The lane center line is generated through segmentation in combination with point selection at equal proportions, so that a data processing amount is relatively small, thereby facilitating improvement in efficiency of generating the lane center line. In addition, after the lane center line is obtained, the lane center line may be further smoothed.

In some embodiments, for first sampling points on a first lane line of a target lane, projection points of the first sampling point on a second lane line of the target lane are determined as first projection points respectively corresponding to the first sampling points; and then the second lane line is divided into a plurality of first segment lines according to the first projection points, and the first lane line is divided into a plurality of second segment lines according to the first sampling points, the plurality of second segment lines and the plurality of first segment lines being in a one-to-one correspondence. Therefore, the lane is properly and finely segmented by performing projection based on the first sampling points, so that subsequently when points are selected on the first segment lines and the second segment lines that have a correspondence according to the same distance proportion, a first reference point and a second reference point that are obtained and have a correspondence are located on the same segment. Even when curvatures of tracks of lane lines on two sides of a curved road are inconsistent, because the granularity of the lane is reduced through segmentation, a deviation of a lane center line generated according to a midpoint between the first reference point and the second reference point can be made smaller, thereby effectively reducing an error of the generated lane center line and improving accuracy of the generated lane center line.

For example, the method for generating a center line in some embodiments may be applied to scenarios such as vehicle navigation, driving assistance, and map drawing and updating.

Although the operations in the flowcharts are displayed sequentially according to the indication of arrows, these operations are not necessarily performed sequentially according to the sequence indicated by the arrows. Unless otherwise explicitly specified in the embodiments, execution of these operations is not strictly limited, and the operations may be performed in other sequences. Moreover, at least some of the operations in the foregoing flowcharts may include a plurality of operations or a plurality of stages. These operations or stages are not necessarily performed at the same time, but may be performed at different time. Execution of these operations or stages is not necessarily sequentially performed, but may be performed in turn or alternately with other operations or at least some of operations or stages of other operations.

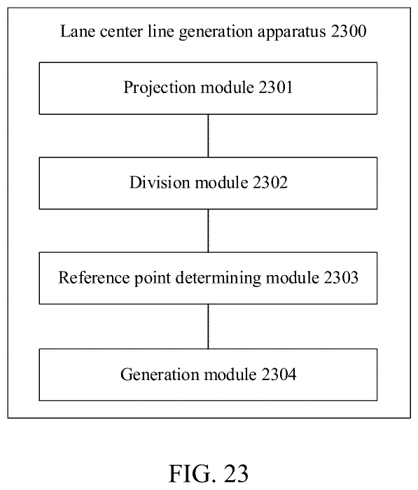

FIG. 23 is a schematic structural diagram of a lane center line generation apparatus according to an embodiment of this application. The lane center line generation apparatus 2300 includes:
a projection module 2301, configured to determine, for first sampling points on a first lane line of a target lane, projection points of the first sampling point on a second lane line of the target lane as first projection points respectively corresponding to the first sampling points, the first lane line and the second lane line being respectively lane lines on two sides of the target lane;
a division module 2302, configured to divide the second lane line into a plurality of first segment lines according to the first projection points, and divide the first lane line into a plurality of second segment lines according to the first sampling points, the plurality of first segment lines and the plurality of second segment lines being in a one-to-one correspondence;
a reference point determining module 2303, configured to perform, according to a same distance proportion, point selection on the first segment lines and the second segment lines that have the correspondence, to obtain first reference points on the first segment lines and second reference points on the second segment lines, the first reference points and the second reference points being in a one-to-one correspondence; and
a generation module 2304, configured to generate a lane center line of the target lane according to midpoints between groups of the first reference points and the second reference points that have the correspondence.

Further, the projection module 2301 is specifically configured to:
generate first tangent lines of the first lane line according to the first sampling points on the first lane line; and
generate first projection lines perpendicular to the first tangent lines based on the first sampling points, and determine the first projection points corresponding to the first sampling points according to first intersection points of the first projection lines and the second lane line.

Further, the projection module 2301 is specifically configured to:
determine respective first distances between the first sampling points and a start point of the first lane line, and determine projection line sorting of the first projection lines in ascending order of the first distances;
determine second distances between the first intersection points and a start point of the second lane line;
sequentially determine target intersection points from the first intersection points respectively corresponding to the first projection lines according to the projection line sequence, second distances of the target intersection points sequentially increasing according to the projection line sequence; and
determine the target intersection points as the first projection points corresponding to the first sampling points.

Further, the projection module 2301 is specifically configured to:
construct a distance matrix of the first intersection points by using the second distances as matrix elements according to the projection line sequence;
input the distance matrix into a projection point determining model, traverse the distance matrix by using the projection point determining model, and determine a target matrix element sequence in the distance matrix, the target matrix element sequence including the plurality of second distances sequentially increasing according to the projection line sequence; and
sequentially determine, according to a position of the target matrix element sequence in the distance matrix, the target intersection points in the plurality of first intersection points respectively corresponding to the first projection lines.

Further, the projection module 2301 is specifically configured to:
determine, when intersecting first projection lines exist, two first sampling points located on the two sides in first sampling points respectively corresponding to the intersecting first projection lines as a first to-be-processed point and a second to-be-processed point along the travelling direction of the target lane;
delete, from the first intersection points of the first projection lines and the second lane line according to a quantity of sampling points between the first to-be-processed point and the second to-be-processed point, a first intersection point corresponding to the first to-be-processed point or the second to-be-processed point; and
determine the first projection points according to remaining first intersection points.

Further, the projection module 2301 is specifically configured to:
delete, from the first intersection points of the first projection lines and the second lane line when the quantity of sampling points between the first to-be-processed point and the second to-be-processed point is greater than or equal to a quantity threshold, a first intersection point corresponding to the second to-be-processed point; or
delete, from the first intersection points of the first projection lines and the second lane line when the quantity of sampling points between the first to-be-processed point and the second to-be-processed point is less than the quantity threshold, a first intersection point corresponding to the first to-be-processed point or the second to-be-processed point.

Further, the division module 2302 is specifically configured to:
determine, for second sampling points between two adjacent first projection points on the second lane line, projection points of the second sampling points on the first lane line as second projection points corresponding to the second sampling points;
divide the second lane line into the plurality of first segment lines along a travelling direction of the target lane according to the first projection points and the second sampling points; and
divide the first lane line into the plurality of second segment lines along the travelling direction according to the first sampling points and the second projection points.

Further, the division module 2302 is specifically configured to:
obtain, for each of the second projection points, first position coordinates of the second projection point and second position coordinates of two target sampling points on the first lane line, the two target sampling points being first sampling points respectively corresponding to two first projection points adjacent to the second sampling point corresponding to the second projection point;
determine a position relationship between the second projection point and the two target sampling points according to the first position coordinates and the second position coordinates;
deleting the second projection point when the position relationship indicates that the second projection point is located beyond the two target sampling points; and
divide the first lane line into the plurality of second segment lines along the travelling direction according to the first sampling points and a remaining second projection point.

Further, the reference point determining module 2303 is specifically configured to:
determine target segment lines in the first segment lines and the second segment lines, and perform point selection on the target segment lines according to a preset distance interval; and
determine a distance proportion according to the distance interval, and perform point selection on other segment lines different from the target segment lines in the first segment lines and the second segment lines according to the distance proportion.

Further, the reference point determining module 2303 is specifically configured to:
determine the first segment lines as the target segment lines when a length of the first segment lines is greater than a length of the second segment lines; or
determine the second segment lines as the target segment lines when a length of the first segment lines is less than a length of the second segment lines; or
determine the first segment lines or the second segment lines as the target segment lines when a length of the first segment lines is equal to a length of the second segment lines.

Further, the generation module 2304 is specifically configured to:
determine, when the first projection point corresponding to the start point of the first lane line does not match the start point of the second lane line, third segment lines on the second lane line according to the start point of the second lane line and the first projection point corresponding to the start point of the first lane line;
perform point selection on the third segment lines, to obtain third reference points; and
generate the lane center line of the target lane according to midpoints between groups of the first reference points and the second reference points that have the correspondence, and midpoints between the third reference points and the start point of the first lane line.

Further, the generation module 2304 is specifically configured to:
perform point selection on the third segment lines according to the preset distance interval, to obtain the third reference points; or
use midpoints of the third segment lines as the third reference points.

The lane center line generation apparatus 2300 and the method for generating a center line are based on the same inventive concept.

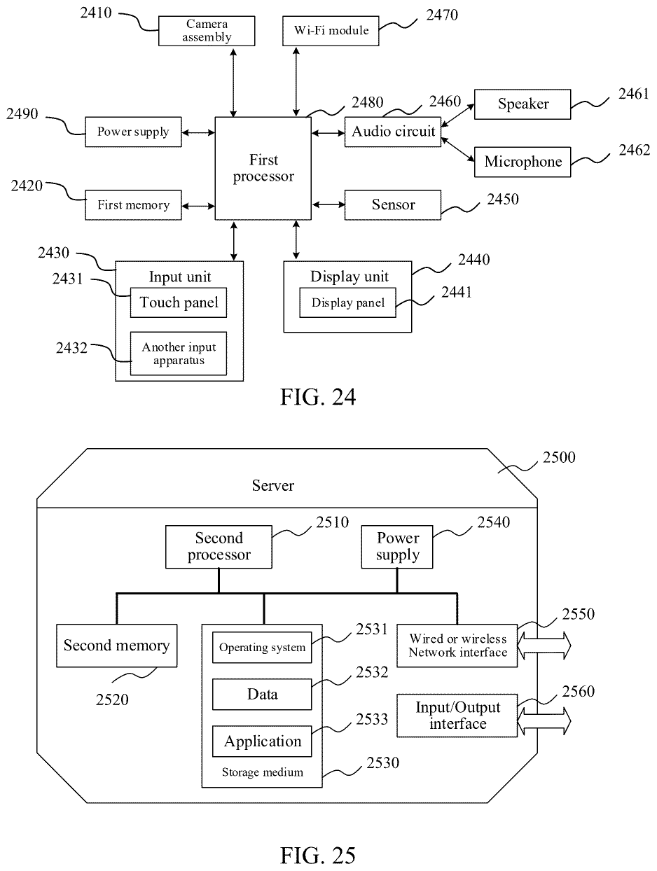

In some embodiments, the electronic device for performing the foregoing method for generating a center line may be a terminal. FIG. 24 is a partial structural block diagram of a terminal according to an embodiment of this application. The terminal includes: components such as a camera assembly 2410, a first memory 2420, an input unit 2430, a display unit 2440, a sensor 2450, an audio circuit 2460, a wireless fidelity (Wi-Fi) module 2470, a first processor 2480, and a power supply 2490. A person skilled in the art may understand that a terminal structure shown in FIG. 24 constitutes no limitation to the terminal, and the terminal may include more or fewer components than those shown in the figure, or some components may be combined, or a different component deployment may be used.

The camera assembly 2410 may be configured to capture an image or a video. In some embodiments, the camera assembly 2410 includes a front-facing camera and a rear-facing camera. Generally, the front-facing camera is disposed on the front panel of the terminal, and the rear-facing camera is disposed on a rear side of the terminal. In some embodiments, at least two rear cameras are arranged, which are respectively any one of a main camera, a depth-of-field camera, a wide-angle camera, and a telephoto camera, to achieve background blur through fusion of the main camera and the depth-of-field camera, panoramic photographing and virtual reality (VR) photographing through fusion of the main camera and the wide-angle camera, or another fusion photographing function.

The first memory 2420 may be configured to store software programs and modules, and the first processor 2480 executes various functional applications and data processing of the terminal by running the software programs and the modules stored in the first memory 2420.

The input unit 2430 may be configured to receive input digit or character information and generate a key signal input related to settings and function control of the terminal. Specifically, the input unit 2430 may include a touch panel 2431 and another input apparatus 2432.

The display unit 2440 may be configured to display input information or provided information, and various menus of the terminal. The display unit 2440 may include a display panel 2441.

The audio circuit 2460, a speaker 2461, and a microphone 2462 may provide audio interfaces.

The power supply 2490 may be an alternating-current power supply, a direct-current power supply, a disposable battery, or a rechargeable battery.

There may be one or more sensors 2450, and the one or more sensors 2450 include but are not limited to: an accelerometer, a gyro sensor, a pressure sensor, an optical sensor, and the like.

The accelerometer may detect a magnitude of acceleration on three coordinate axes of a coordinate system established with the terminal. For example, the accelerometer may be configured to detect components of gravity acceleration on the three coordinate axes. The first processor 2480 may control, based on a gravity acceleration signal collected by the accelerometer, the display unit 2440 to display the user interface in a landscape view or a portrait view. The accelerometer may be further configured to acquire motion data of a game or a user.

The gyroscope sensor may detect a body direction and a rotation angle of the terminal, and the gyroscope sensor may work with the accelerometer to collect a 3D action performed by the user on the terminal. The first processor 2480 may implement the following functions based on data collected by the gyroscope sensor: action sensing (such as changing a UI based on a tilt operation of the user), image stabilization during shooting, game control, and inertial navigation.

The pressure sensor may be disposed at a side frame of the terminal and/or a lower layer of the display unit 2440. When the pressure sensor is disposed at the side frame of the terminal, a holding signal of the user on the terminal may be detected. The first processor 2480 performs left/right hand recognition or a quick operation according to the holding signal acquired by the pressure sensor. When the pressure sensor is disposed on the low layer of the display unit 2440, the first processor 2480 controls an operable control on the UI based on a pressure operation by the user for the display unit 2440. The operable control includes at least one of a button control, a scroll bar control, an icon control, and a menu control.

The optical sensor is configured to collect ambient light intensity. In an embodiment, the first processor 2480 may control display luminance of the display unit 2440 according to the ambient light intensity collected by the optical sensor. Specifically, when the ambient light intensity is relatively high, the display brightness of the display unit 2440 is increased. When the ambient light intensity is relatively low, the display brightness of the display unit 2440 is reduced. In another embodiment, the first processor 2480 may further dynamically adjust a camera parameter of the camera assembly 2410 according to the ambient light intensity acquired by the optical sensor.

In this embodiment, the first processor 2480 included in the terminal can perform the method for generating a center line in the foregoing embodiments.

In some embodiments, the electronic device for performing the foregoing method for generating a center line may alternatively be a server. FIG. 25 is a partial structural block diagram of a server according to an embodiment of this application. The server 2500 may vary greatly due to different configurations or performance, and may include one or more second processors 2510, a second memory 2520, and one or more storage media 2530 (for example, one or more mass storage apparatuses) that store an application 2533 or data 2532. The second memory 2520 and the storage medium 2530 may be temporarily stored or permanently stored. A program stored in the storage medium 2530 may include one or more modules (not marked in the figure), and each module may include a series of instruction operations on the server 2500. In addition, the second processor 2510 may be configured to communicate with the storage medium 2530, and perform, on the server 2500, the series of instruction operations in the storage medium 2530.

The server 2500 may further include one or more power supplies 2540, one or more wired or wireless network interfaces 2550, one or more input/output interfaces 2560, and/or one or more operating systems 2531, for example, Windows Server™, Mac OS X™, Unix™, Linux™, and Free BSD™.

The second processor 2510 in the server 2500 may be configured to execute the method for generating a center line.

An embodiment of this application further provides a computer-readable storage medium, where the computer-readable storage medium is configured to store a computer program, and the computer program is configured to perform the method for generating a center line according to each of the foregoing embodiments.

An embodiment of this application further provides a computer program product, where the computer program product includes a computer program, and the computer program is stored in a computer-readable storage medium. A processor of a computer device reads the computer program from the computer-readable storage medium, and the processor executes the computer program, to cause the computer device to perform the foregoing method for generating a center line.

In the specification and accompanying drawings of this application, the terms “first”, “second”, “third”, “fourth”, and so on (if existent) are intended to distinguish between similar objects but do not necessarily indicate a specific order or sequence. Data used in this way is interchangeable in a suitable case, so that the embodiments of this application described can, for example, be implemented in an order other than those illustrated or described herein. Moreover, the terms “include”, “contain” and any other variants mean to cover the non-exclusive inclusion. For example, a process, method, system, product, or apparatus that includes a list of operations or units is not necessarily limited to those operations or units, but may include other operations or units not expressly listed or inherent to such a process, method, product, or apparatus.

In this application, “at least one (item)” means one or more, and “a plurality of” means two or more. The term “and/or” describes an association between associated objects and represents that three associations may exist. For example, “A and/or B” may indicate: only A exists, only B exists, and both A and B exist, where A and B may be singular or plural. A character “/” generally indicates an “or” relationship between associated objects. “At least one of the following” or a similar expression thereof refers to any combination of these items, including one item or any combination of a plurality of items. For example, at least one item of a, b, or c may indicate a, b, c, “a and b”, “a and c”, “b and c”, or “a, b, and c”, where a, b, and c may be singular or plural.

In the descriptions of the embodiments of this application, a plurality of (or multiple) means two or more, being greater than, being less than, exceeding a number, and the like are understood as excluding the number, and above, below, within a number, and the like are understood as including the number.

In some embodiments in this application, the system, apparatus, and method disclosed may be implemented in other modes. For example, the apparatus embodiments described above are merely illustrative. For example, the units are divided merely by logical function. Other division methods can be used in some embodiments. For example, a plurality of units or components can be combined or integrated into another system, or some features can be ignored or not performed. In addition, displayed or discussed mutual couplings or direct couplings or communication connections may be implemented through some interfaces. Indirect couplings or communication connections between apparatuses or units may be implemented in electronic, mechanical, or other forms.

The units described as separate parts may or may not be physically separate, and parts displayed as units may or may not be physical units, may be located in one position, or may be distributed on a plurality of network units. Some of or all of the units may be selected based on requirements to achieve objectives of the solutions of embodiments.

In addition, functional units in embodiments of this application may be integrated into one processing unit, or each of the units may exist alone physically, or two or more units may be integrated into one unit. The integrated unit may be implemented in a form of hardware, or may be implemented in a form of a software function unit.

The integrated unit, if implemented in the form of a software functional unit and sold or used as an independent product, can be stored in a computer-readable storage medium. Based on this understanding, the technical solutions of this application essentially, a part contributing to the related art, or all or a part of the technical solutions may be implemented in a form of a software product. The computer software product is stored in a storage medium, and includes several instructions to enable a computer apparatus (which may be a personal computer, a server, a network apparatus, or the like) to perform all or a part of the operations of the methods in the embodiments of this application. The foregoing storage medium includes: any medium that can store program code, such as a USB flash disk, a removable hard disk, a read-only memory (ROM), a random access memory (RAM), a magnetic disk, or an optical disc.

The implementations in the embodiments of this application may be combined in different manners to achieve different technical effects.

The foregoing describes various implementations of this application in detail, but this application is not limited to the foregoing implementations. A person skilled in the art may further make various equivalent variants or replacements without departing from the spirit of this application, and these equivalent variants or replacements are all included within the scope defined by the claims of this application.

What is claimed is:

1. A method for generating a center line, performed by an electronic device, and comprising:
determining, corresponding to first sampling points on a first lane line of a target lane, projection points of the first sampling point on a second lane line of the target lane as first projection points respectively corresponding to the first sampling points, the first lane line and the second lane line being respectively lane lines on two sides of the target lane;
dividing the second lane line into a plurality of first segment lines according to the first projection points, and dividing the first lane line into a plurality of second segment lines according to the first sampling points, the plurality of first segment lines and the plurality of second segment lines being in a one-to-one correspondence;
selecting first reference points on the first segment lines and second reference points on the second segment lines according to a same distance proportion, the first reference points and the second reference points being in a one-to-one correspondence; and
generating a lane center line of the target lane according to midpoints between groups of the first reference points and the corresponding second reference points.

2. The method for generating a center line according to claim 1, the dividing the second lane line into a plurality of first segment lines according to the first projection points, and dividing the first lane line into a plurality of second segment lines according to the first sampling points comprising:
determining, for second sampling points between two adjacent first projection points on the second lane line, projection points of the second sampling points on the first lane line as second projection points corresponding to the second sampling points;
dividing the second lane line into the plurality of first segment lines along a travelling direction of the target lane according to the first projection points and the second sampling points; and
dividing the first lane line into the plurality of second segment lines along the travelling direction according to the first sampling points and the second projection points.

3. The method for generating a center line according to claim 2, the dividing the first lane line into the plurality of second segment lines along the travelling direction according to the first sampling points and the second projection points comprising:
obtaining first position coordinates of the second projection point and second position coordinates of two target sampling points on the first lane line for each of the second projection points, the two target sampling points being first sampling points respectively corresponding to two first projection points adjacent to the second sampling point corresponding to the second projection point; determining a position relationship between the second projection point and the two target sampling points according to the first position coordinates and the second position coordinates; deleting the second projection point when the position relationship indicates that the second projection point is located beyond the two target sampling points; and
dividing the first lane line into the plurality of second segment lines along the travelling direction according to the first sampling points and a remaining second projection point.

4. The method for generating a center line according to claim 1, the determining, for first sampling points on a first lane line of a target lane, projection points of the first sampling point on a second lane line of the target lane as first projection points respectively corresponding to the first sampling points comprising:
generating first tangent lines of the first lane line according to the first sampling points on the first lane line; and
generating first projection lines perpendicular to the first tangent lines based on the first sampling points, and determining the first projection points corresponding to the first sampling points according to first intersection points of the first projection lines and the second lane line.

5. The method for generating a center line according to claim 4, the determining the first projection points corresponding to the first sampling points according to first intersection points of the first projection lines and the second lane line comprising:
determining respective first distances between the first sampling points and a start point of the first lane line, and determining projection line sequence by sorting the first projection lines in ascending order of the first distances;
determining second distances between the first intersection points and a start point of the second lane line;
sequentially determining target intersection points from the first intersection points respectively corresponding to the first projection lines according to the projection line sequence, second distances of the target intersection points sequentially increasing according to the projection line sequence; and
determining the target intersection points as the first projection points corresponding to the first sampling points.

6. The method for generating a center line according to claim 5, the sequentially determining target intersection points from the first intersection points respectively corresponding to the first projection lines according to the projection line sequence comprising:
constructing a distance matrix of the first intersection points by using the second distances as matrix elements according to the projection line sequence;
inputting the distance matrix into a projection point determining model, traversing the distance matrix by using the projection point determining model, and determining a target matrix element sequence in the distance matrix, the target matrix element sequence comprising the plurality of second distances sequentially increasing according to the projection line sequence; and
sequentially determining the target intersection points in the plurality of first intersection points respectively corresponding to the first projection lines according to a position of the target matrix element sequence in the distance matrix.

7. The method for generating a center line according to claim 4, the determining the first projection points corresponding to the first sampling points according to first intersection points of the first projection lines and the second lane line comprising:
determining, when intersecting first projection lines exist, two first sampling points located on the two sides in first sampling points respectively corresponding to the intersecting first projection lines as a first to-be-processed point and a second to-be-processed point along the travelling direction of the target lane;
deleting, from the first intersection points of the first projection lines and the second lane line according to a quantity of sampling points between the first to-be-processed point and the second to-be-processed point, a first intersection point corresponding to the first to-be-processed point or the second to-be-processed point; and
determining the first projection points according to a remaining first intersection point.

8. The method for generating a center line according to claim 7, the deleting, from the first intersection points of the first projection lines and the second lane line according to a quantity of sampling points between the first to-be-processed point and the second to-be-processed point, a first intersection point corresponding to the first to-be-processed point or the second to-be-processed point comprising:
deleting, from the first intersection points of the first projection lines and the second lane line when the quantity of sampling points between the first to-be-processed point and the second to-be-processed point is greater than or equal to a quantity threshold, a first intersection point corresponding to the second to-be-processed point; or
deleting, from the first intersection points of the first projection lines and the second lane line when the quantity of sampling points between the first to-be-processed point and the second to-be-processed point is less than the quantity threshold, a first intersection point corresponding to the first to-be-processed point or the second to-be-processed point.

9. The method for generating a center line according to claim 1, the performing, according to a same distance proportion, point selection on the first segment lines and the corresponding second segment lines comprising:
determining target segment lines in the first segment lines and the second segment lines, and performing point selection on the target segment lines according to a preset distance interval; and
determining a distance proportion according to the distance interval, and performing point selection on other segment lines different from the target segment lines in the first segment lines and the second segment lines according to the distance proportion.

10. The method for generating a center line according to claim 9, the determining target segment lines in the first segment lines and the second segment lines comprising:
determining the first segment lines as the target segment lines when a length of the first segment lines is greater than a length of the second segment lines; or
determining the second segment lines as the target segment lines when a length of the first segment lines is less than a length of the second segment lines; or
determining the first segment lines or the second segment lines as the target segment lines when a length of the first segment lines is equal to a length of the second segment lines.

11. The method for generating a center line according to claim 1, the generating a lane center line of the target lane according to midpoints between groups of the first reference points and the corresponding second reference points comprising:
determining, when the first projection point corresponding to the start point of the first lane line does not match the start point of the second lane line, third segment lines on the second lane line according to the start point of the second lane line and the first projection point corresponding to the start point of the first lane line;
performing point selection on the third segment lines, to obtain third reference points; and
generating the lane center line of the target lane according to midpoints between groups of the first reference points and the corresponding second reference points, and midpoints between the third reference points and the start point of the first lane line.

12. The method for generating a center line according to claim 11, the performing point selection on the third segment lines, to obtain third reference points comprising:
selecting the third reference points on the third segment lines according to the preset distance interval; or
using midpoints of the third segment lines as the third reference points.

13. An electronic device, comprising a memory and a processor, the memory having a computer program stored therein, and the processor, when executing the computer program, implementing a method for generating a center line comprising:
determining, corresponding to first sampling points on a first lane line of a target lane, projection points of the first sampling point on a second lane line of the target lane as first projection points respectively corresponding to the first sampling points, the first lane line and the second lane line being respectively lane lines on two sides of the target lane;
dividing the second lane line into a plurality of first segment lines according to the first projection points, and dividing the first lane line into a plurality of second segment lines according to the first sampling points, the plurality of first segment lines and the plurality of second segment lines being in a one-to-one correspondence;
selecting first reference points on the first segment lines and second reference points on the second segment lines according to a same distance proportion, the first reference points and the second reference points being in a one-to-one correspondence; and
generating a lane center line of the target lane according to midpoints between groups of the first reference points and the corresponding second reference points.

14. The electronic device for generating a center line according to claim 13, the dividing the second lane line into a plurality of first segment lines according to the first projection points, and dividing the first lane line into a plurality of second segment lines according to the first sampling points comprising:
determining, for second sampling points between two adjacent first projection points on the second lane line, projection points of the second sampling points on the first lane line as second projection points corresponding to the second sampling points;
dividing the second lane line into the plurality of first segment lines along a travelling direction of the target lane according to the first projection points and the second sampling points; and
dividing the first lane line into the plurality of second segment lines along the travelling direction according to the first sampling points and the second projection points.

15. The electronic device for generating a center line according to claim 14, the dividing the first lane line into the plurality of second segment lines along the travelling direction according to the first sampling points and the second projection points comprising:
Obtaining first position coordinates of the second projection point and second position coordinates of two target sampling points on the first lane line for each of the second projection points, the two target sampling points being first sampling points respectively corresponding to two first projection points adjacent to the second sampling point corresponding to the second projection point; determining a position relationship between the second projection point and the two target sampling points according to the first position coordinates and the second position coordinates; deleting the second projection point when the position relationship indicates that the second projection point is located beyond the two target sampling points; and
dividing the first lane line into the plurality of second segment lines along the travelling direction according to the first sampling points and a remaining second projection point.

16. The electronic device for generating a center line according to claim 13, the determining, for first sampling points on a first lane line of a target lane, projection points of the first sampling point on a second lane line of the target lane as first projection points respectively corresponding to the first sampling points comprising:
generating first tangent lines of the first lane line according to the first sampling points on the first lane line; and
generating first projection lines perpendicular to the first tangent lines based on the first sampling points, and determining the first projection points corresponding to the first sampling points according to first intersection points of the first projection lines and the second lane line.

17. The electronic device for generating a center line according to claim 16, the determining the first projection points corresponding to the first sampling points according to first intersection points of the first projection lines and the second lane line comprising:
determining respective first distances between the first sampling points and a start point of the first lane line, and determining projection line sequence by sorting the first projection lines in ascending order of the first distances;
determining second distances between the first intersection points and a start point of the second lane line;
sequentially determining target intersection points from the first intersection points respectively corresponding to the first projection lines according to the projection line sequence, second distances of the target intersection points sequentially increasing according to the projection line sequence; and
determining the target intersection points as the first projection points corresponding to the first sampling points.

18. The electronic device for generating a center line according to claim 17, the sequentially determining target intersection points from the first intersection points respectively corresponding to the first projection lines according to the projection line sequence comprising:
constructing a distance matrix of the first intersection points by using the second distances as matrix elements according to the projection line sequence;
inputting the distance matrix into a projection point determining model, traversing the distance matrix by using the projection point determining model, and determining a target matrix element sequence in the distance matrix, the target matrix element sequence comprising the plurality of second distances sequentially increasing according to the projection line sequence; and
sequentially determining the target intersection points in the plurality of first intersection points respectively corresponding to the first projection lines according to a position of the target matrix element sequence in the distance matrix.

19. A non-transitory computer-readable storage medium, having a computer program stored therein, the computer program, when executed by a processor, implementing a method for generating a center line comprising:
determining, corresponding to first sampling points on a first lane line of a target lane, projection points of the first sampling point on a second lane line of the target lane as first projection points respectively corresponding to the first sampling points, the first lane line and the second lane line being respectively lane lines on two sides of the target lane;
dividing the second lane line into a plurality of first segment lines according to the first projection points, and dividing the first lane line into a plurality of second segment lines according to the first sampling points, the plurality of first segment lines and the plurality of second segment lines being in a one-to-one correspondence;
selecting first reference points on the first segment lines and second reference points on the second segment lines according to a same distance proportion, the first reference points and the second reference points being in a one-to-one correspondence; and
generating a lane center line of the target lane according to midpoints between groups of the first reference points and the corresponding second reference points.

20. The computer-readable storage medium for generating a center line according to claim 19, the dividing the second lane line into a plurality of first segment lines according to the first projection points, and dividing the first lane line into a plurality of second segment lines according to the first sampling points comprising:
determining, for second sampling points between two adjacent first projection points on the second lane line, projection points of the second sampling points on the first lane line as second projection points corresponding to the second sampling points;
dividing the second lane line into the plurality of first segment lines along a travelling direction of the target lane according to the first projection points and the second sampling points; and
dividing the first lane line into the plurality of second segment lines along the travelling direction according to the first sampling points and the second projection points.
